(19) United States
(12) Patent Application Publication
(10) Pub. No.: US 2021/0365955 A1
(43) Pub. Date: Nov. 25, 2021

(54) CONTEXTUAL HELP MODULES

(71) Applicant: STATE FARM MUTUAL AUTOMOBILE INSURANCE COMPANY, Bloomington, IL (US)

(72) Inventors: Christopher R. Galante, Normal, IL (US); Jeffrey C. Mousty, Normal, IL (US); Steven J. Reeves, Normal, IL (US); Cynthia Burch, Mahomet, IL (US); Sally L. Rieker Salegna, Bloomington, IL (US); Timothy J. Kreuz, Bloomington, IL (US); Brian Sturch, Bloomington, IL (US); Andrew M. Baumann, Bloomington, IL (US); Daniel Becicka, Bloomington, IL (US)

(21) Appl. No.: 14/876,412

(22) Filed: Oct. 6, 2015

Related U.S. Application Data
(60) Provisional application No. 62/109,164, filed on Jan. 29, 2015.

(51) Int. Cl. G06Q 30/00; G06F 3/0481; G06F 3/0484

(52) U.S. Cl. CPC G06Q 30/016; G06F 3/04842; G06F 3/04817

(57) ABSTRACT

A contextual help module may allow an enterprise to provide multiple help capabilities across multiple lines-of-business (LOBs) of the enterprise with consistency. The contextual help module may be integrated onto any display view of any LOB of the enterprise, and may render contextual help information and/or dynamically route a customer's help request to a receiving help capability based upon the context of the customer help request. Further, the contextual help module may provide a layer of indirection or abstraction between customer-facing processes and the architectures providing the various help capabilities so that implementation and updating times and costs for help capabilities may be minimized. The multiple LOBs may relate to insurance, such as auto, home, life, health, renters, personal articles, or other insurance. The dynamic routing of the user to appropriate online help may be based upon functional area of the help, LOB, sub-LOB, preferred customer language, and/or customer location.

### CROSS-REFERENCE TO RELATED APPLICATIONS

This application claims priority to and the benefit of U.S. Provisional Application No. 62/109,164, entitled “Contextual Help Modules” and filed on Jan. 29, 2015, the entire disclosure of which is hereby expressly incorporated by reference herein.

### FIELD OF THE DISCLOSURE

This disclosure generally relates to a contextual help module that may be integrated with multiple display views of multiple lines-of-business (LOB) of an enterprise.

### BACKGROUND

An enterprise may own and/or operate a plurality of lines-of-businesses (LOBs). Generally, as referred to herein, a line-of-business of an enterprise may be an entity of the enterprise that provides a set of services to meet a particular customer need. Different lines-of-business within an enterprise typically provide different sets of services, and/or different lines-of-business within an enterprise may be run as separate profit/loss centers, subsidiaries, divisions, business units, or other types of “child” organizations of the enterprise.

For example, a pharmaceutical enterprise may include a retail pharmacy LOB; a specialty pharmacy LOB that provides pharmaceutical services for more complex health conditions such as HIV/AIDS, cancer, transplants and the like; a mail-order, Internet-order or other remote pharmacy LOB; a home care service LOB; and/or a home infusion LOB. In another example, a restaurant enterprise may include a fast food chain LOB, a casual dining chain LOB, a high-end dining chain LOB, and a catering service LOB.

In yet another example, an insurance and financial services enterprise may include various LOBs that provide different insurance products (e.g., an automobile LOB, a life insurance LOB, a property insurance LOB, etc.) and/or various LOBs that provide financial products, such as mutual funds, checking accounts, certificates of deposits, mortgages, etc. LOBs may be branded as sub-entities of the enterprise (e.g., ACME Life Insurance, ACME Investment Services, ACME Auto Insurance, etc.), or each LOB of an enterprise may be branded as a unique entity although it is owned, operated, and/or otherwise controlled by the enterprise.

Typically, each LOB of an enterprise may provide its own electronic customer interface or interfaces. For example, each LOB of an enterprise may provide a LOB-specific display view, e.g., by use of a webpage, a server or client application, an application or a module that is downloadable to customer's device, etc. The LOB-specific display views may include one or more LOB-specific help capabilities that allow a user to obtain information particular to a LOB and/or that allow a user to obtain answers to any questions that he or she might have.

Typically, each LOB-specific help capability may be directly connected to a vendor platform on which the LOB-specific help capability is built and provided. For example, LOB-specific display view may be directly connected to a first vendor platform in order to provide a chat capability, and may be directly connected to another vendor platform to provide a list of Frequently Asked Questions (FAQs) and their corresponding answers.

Usually, the connection between the display view and each vendor platform may use a particular format and syntax required by the vendor platform. Further, the various types of data that each vendor platform expects to receive and is able to send may also be pre-defined and particular to the display view and/or to the specific LOB providing the display view. As such, the different help capabilities provided by different LOBs of an enterprise may each have a different and inconsistent use, look, and feel, even if they are of a similar type. Furthermore, the LOB-specific help capabilities may be difficult and costly to maintain across an enterprise, as each LOB-specific help capability may be built on different, LOB-specific vendor platforms and/or have different respective, tightly-coupled connections to the platforms, different required and desired customer data, business-specific data, etc. that are specific to the providing LOB.

### SUMMARY

The techniques, systems, and methods disclosed herein may provide a contextual help module that allows an enterprise to provide multiple help capabilities across multiple lines-of-business (LOBs) of the enterprise with consistency. The contextual help module may be integrated onto, or with, any display view of any LOB of the enterprise, and may render contextual help information. Additionally or alternatively, the contextual help module may route a customer's help request to a receiving help capability based upon the context of the customer help request. Further, the contextual help module may provide a layer of indirection or abstraction between customer-facing processes and the architectures providing the various help capabilities so that implementation and updating times and/or costs for help capabilities are minimized.

In one aspect, a contextual help module for an enterprise having a plurality of lines-of-business (LOBs) may include an input to receive a respective identifier of a specific line-of-business (LOB) of the enterprise. The respective identifier of the specific LOB may be received at a display view with which the contextual help module is integrated and that is provided by the any LOB, for example.

The contextual help module may further include one or more sets of computer-executable instructions that are stored on one or more memories and executable by one or more processors. When executed, the computer-executable instructions may cause the contextual help module to determine, based upon the respective identifier of the specific LOB and a set of routing rules, a particular help capability from a set of help capabilities that is particular to the specific LOB. Each help capability of the set of help capabilities may be configured to allow a user to obtain information pertaining to the specific LOB, for example.

Additionally, the computer-executable instructions may cause the particular help capability to receive data indicative of an interaction of the user at the respective display view provided by the specific LOB, and/or may cause the presentation, at the respective display view provided by the specific LOB, of data generated by the particular help capability in response to receiving the data indicative of the user interaction.

In another aspect, a contextual help module for an enterprise having a plurality of lines-of-business (LOBs) may include an input to receive a respective identifier of any (or a specific) line-of-business (LOB) of the enterprise. The respective identifier of the specific LOB may be received at a display view with which the contextual help module is integrated and/or that is provided by the specific LOB, for example.

The contextual help module may further include computer-executable instructions that are stored on one or more memories and that are executable by one or more processors to (i) determine, based upon the respective identifier of the specific LOB, a set of help capabilities particular to the specific LOB and configured to allow a user to obtain information about the specific LOB; (ii) provide, in conjunction with the respective display view provided by the specific LOB, a respective indication of each member of the set of help capabilities of the specific LOB; (iii) receive an indication of a user selection of one of the members of the set of help capabilities of the specific LOB; (iv) provide, in conjunction with the respective display view provided by the specific LOB and based upon the user selection, information particular to the selected help capability of the set of help capabilities of the specific LOB; and/or (v) provide, to the specific LOB, data indicative of the user selection of the selected help capability of the specific LOB.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram of an exemplary enterprise system including a contextual help module, in accordance with some embodiments;

FIG. 2 is a block diagram of an exemplary contextual help module, in accordance with some embodiments; and

FIG. 3 is an exemplary method of contextually rendering help information, in accordance with some embodiments;

FIG. 4 is an exemplary method of contextually routing a help request to a receiving help capability, in accordance with some embodiments; and

FIG. 5 is an exemplary enterprise system including a contextual help module, in accordance with some embodiments.

### DETAILED DESCRIPTION

The present embodiments may relate to, inter alia, a single, logical contextual help module that may allow an enterprise to provide multiple help or collaboration capabilities (e.g., chat, email, call, call-back, Frequently Asked Questions (FAQs), and/or any other desired help capabilities) across multiple lines-of-business (LOBs) of the enterprise with minimal implementation and service costs. The contextual help module may be integrated onto any display view of any LOB of the enterprise, and may be configured to render contextual help information and/or to route a customer's help request to a receiving help capability based upon the context of a customer help request.

The “context” of a customer's help request may correspond to any number of characteristics, e.g., of the customer, of the content or intent of the customer's request, of the display view and/or the type of display via which the help request is received, of a particular LOB, of one or more interactions of the customer with the display view (or lack thereof), and/or any other contextual characteristic or factor surrounding the help request. Further, the contextual help module may provide a layer of indirection or abstraction between customer-facing processes and the architectures providing the various help capabilities so that implementation and updating times and/or costs for help capabilities are minimized, as will be described below.

The present embodiments may relate to creating a Common Reusable Help Module that may be contextually integrated on any web page which would provide contextual collaboration capabilities that allow the customer to interact with agents and first responders or other company representatives. For example, the Common Reusable Help Module may be utilized to address, or enhance the online customer experience regarding the following (as well as others) scenarios: (1) a customer may like to chat with a “first responder” about the quote process; (2) a customer may be at an insurance or financial business web page and would like to chat with their insurance agent, however, the agent is unavailable, prompting the customer to compose an email to their agent or chat with a customer care representative; (3) a customer may be looking into some life insurance, for example, and has utilized Frequently Asked Questions to help them understand the different types of life insurance better; and/or (4) a customer may be at an auto insurance-related web page and would like someone to call them back in regards to a quote for auto (or other types of) insurance. The associated agent and/or first responders may have expertise associated with the context (such as a web page or page element) that the Help Module was integrated into. The adoption of this Help Module may promote consistency, and centralized administration, development, and/or service of current and future collaboration capabilities.

The present embodiments may provide platform agnostic integration of multiple collaboration capabilities to agents and/or first responder groups. Each context that the help module may be integrated into, and/or managed through, may include subscription and optional data. The ability to associate individual subscriptions of the help module to agents (or other groups) and their capabilities may be provided. Hours of operation may be set for all capabilities. New or updated capabilities and collaboration business logic may be added for enterprise adoption with minimal coding changes. Integration with existing group management and/or workflow management solutions for routing and rendering of capabilities for customers may also be provided. Additionally or alternatively, a layer of indirection may be created between any vendors providing any collaboration capabilities and/or business process context.

The contextual help module may provide dynamic routing to certain insurance provider representatives and/or specific LOB information and products/services. The dynamic routing may be provided across multiple LOBs web pages. The dynamic routing may be based upon a number of factors, such as customer state, LOB, LOB subtype or Sub-LOB, language, customer location, functional or other areas, and/or other factors.

The contextual help module may allow individual LOBs to turn on and/or turn off certain help functionality or capabilities. Dynamic routing may be by state, chat requests, language preferences, when first responders/agents/representatives are available, etc. Based upon a subscription identification, customer information (for example, customer name, address, contact information, email address, etc.) may be pre-populated into certain fields of customer inquiry web pages, such as requests for additional information on certain types of insurance, insurance products, insurance services, and/or financial products/services. The auto-populate functionality may provide a consistent look-and-feel across multiple LOBs that provide services via a communications network, such as the internet, and/or an insurance or financial services provider (or other) website.

The contextual help module may provide proactive help rules. The proactive help rules may facilitate enhancing an online customer experience by moving or prompting a customer through the process or processes of receiving insurance product quotes, submitting insurance claims, updating customer information (such as contact information or insurance policy information), paying insurance policy premiums, etc. As one example, the proactive help rules may prompt an online user and ask if they need or want assistance if they have been viewing an insurance provider web page for too long a time without any user activity (such as one or two minutes without clicking a mouse or moving to another web page).

In one aspect, the contextual help module may provide dynamic routing based upon one or more factors. The factors may include the (i) function or operation (or functional area) that the online customer is attempting to achieve. For instance, the online customer may be attempting to (1) acquire a quote for an insurance product or service, (2) submit an insurance claim, (3) receive information about various insurance products or services, (4) pay an insurance premium, (5) update customer information or information about items insured (e.g., vehicles, homes, drivers, persons, personal articles, etc.), and/or perform other actions, such as actions related to insurance and/or financial products or services, including vehicle or home loans.

The factors may include (ii) a LOB for which the user interest or activity relates to. For instance, the user activity may relate to auto, fire, home, life, health, personal articles, and/or other types of insurance. Additionally or alternatively, the user activity may relate to acquiring a loan, such as a vehicle loan.

The factors may also relate to (iii) a sub-LOB. For instance, for vehicle insurance and/or a vehicle loan, the sub-LOB may relate to the type of vehicle and/or vehicle characteristics, such as automobile, sport utility vehicle (SUV), truck, motor cycle, motor home, vehicle features, etc. For home insurance and/or a home loan, the sub-LOB may relate to the type of home and/or home characteristics, such as square footage, location, number of stories, number of bed or bath rooms, types of windows, types of flooring or cabinets, features, etc.

The factors may relate to (iv) a language preference for the online customer. The language preferences may be English, Spanish, German, French, etc.

The contextual help module may provide dynamic routing based upon analysis of the one or more factors mentioned above and in conjunction with location of the online customer. For instance, based upon the location, state code, zip code, internet address, etc. of the online customer, and/or based upon one or more the factors mentioned above (i.e., function or functional area, LOB, sub-LOB, and/or preferred language), the online customer may be dynamically directed or re-directed to specific and relevant help-related web pages (associated with specific LOBs of an insurance provider for example) that provide relevant information, and/or assistance to the online customer.

In one embodiment, based upon a location of an insurance customer, such as determined from GPS location or an internet address associated with the online customer, and a context for which help is sought by the online customer (e.g., function or functional area, LOB, sub-LOB, and/or preferred language), the contextual help module may dynamically direct the online customer to a web page associated with the context and/or associated information, products, and/or services.

### I. Exemplary Help Module

In one aspect, a help module may be provided that includes context, re-usable, and/or platform adoption independent features. The help module may have a number of variants, such as customer call center support, 1-800, FAQ, and/or invisible (providing client side APIs) variants.

The help module may be rendered based upon the following criteria provided by the business process page: Subscription Id (which may be required); Optional Data Key/Value (used for further tuning the context); Module Display Type; and Customer State Abbreviation. For instance, the Optional Data Key/Value may include and/or be associated with a free form text field (flexible), and a recommended template (customer or sales associate), (page name), (state), etc.

The Module Display Type may include and/or be associated with a PersistentHelpModule (e.g., CCC Support, 1-800, FAQ, and Invisible (providing client side APIs)). The Module Display Type may also include a module for vendor application adoption compatibility.

The Customer State Abbreviation may be determined by business or LOB page. If not provided by business page, the Customer State Abbreviation may be provided by an authenticated customer's street address state abbreviation. If the above is not provided, the state abbreviation may be retrieved or determined based upon the customer geo location.

Other data may be passed in to improve the customer's online experience by pre-populating text boxes. For instance, Customer Name; Customer Phone Number; and/or Customer Email addresses may be pre-populated on help web pages. Misc. Data may be used to control help center behavior, and/or may include use of Tab Override and/or Associate Id functionality.

Upon a business process page call to the help module, the following may occur within a computer-implemented method: (1) retrieval of subscription metadata; (2) a check for an active subscription (if not active, then help module does not render); (3) retrieval of customer text to be presented on the help module pages per the business profile identifier indicated in the subscription metadata; and/or (4) identify the Active Customer Care Representative group based upon: (i) Function, (ii) Line of Business, (iii) Sub-Line of Business, (iv) Customer Language, and/or (v) State/Province. Also, the method may include (5) retrieving capabilities metadata per customer care group retrieved, which may include the following (but not limited to): capability type (chat, email, callback, etc.); capability connection info; capability hours of operation; capability active timestamp (determines whether it can be used); capability catastrophe closure (True/False) (emergency shutdown trigger or trigger event); capability language (English/Spanish); and/or capability priority (primary, secondary, escalate, etc.). The method may include (6) retrieving capabilities directly related to subscription, which may be associated with usually Frequently Asked Question or Phone Number. The method may include (7) retrieving selected agent metadata; and/or (8) retrieving agent capabilities metadata (such as the same metadata described above with respect to customer care group capabilities metadata).

The results from the retrieval process influences how the help module renders (CCC, FAQ Only, 1-800, invisible, or not render because not active). Unavailable page render functionality may apply when a representative or agent is not available based upon actual availability, or availability per hours of operation for the capability request to be used by the customer. All pages related to the help module are in-language compliant, which means the help module may be rendered in any language (English, Spanish, etc.) given content translation has occurred for that language.

All pages related to the help module may be WCAG 2.0 Level A Accessibility and Accessibility Ontarians Disability Act Compliant. Asynchronously loads of content may prevent the help module from impairing or reducing the load time of the LOB or business process page. Customer sensitive data may be securely passed and/or persisted. The method may provide hooks to the help center for other modules and/or widgets on an insurance provider website to provide hyperlinks to the customer for the help center. Access collaboration capabilities may be provided via mobile devices, tablets, or desktop computers.

The help module may provide Help Module Collaboration Interaction Tracking functionality. For instance, it may track customer collaboration interactions with an insurance or financial services provider. The services data may be used for metrics and reporting, CRM, and/or customer access to collaboration history with the insurance or financial services provider.

The help module may provide Help Module Integration functionality that integrates the help module with multiple collaborating vendor products. The functionality may allow for multiple chat, email, callback, etc. vendors to hook into the help module with little additional development. The services may be provided as a layer of indirection for the business process and the vendor products. If the vendor product no longer meets the business needs, it may be shut down and replaced with minimal or no involvement by the business process. The functionality may allow for co-existence of collaboration solution vendors to enable greatest flexibility for various LOBs or business area's needs.

### II. Exemplary System Having a Contextual Help Module

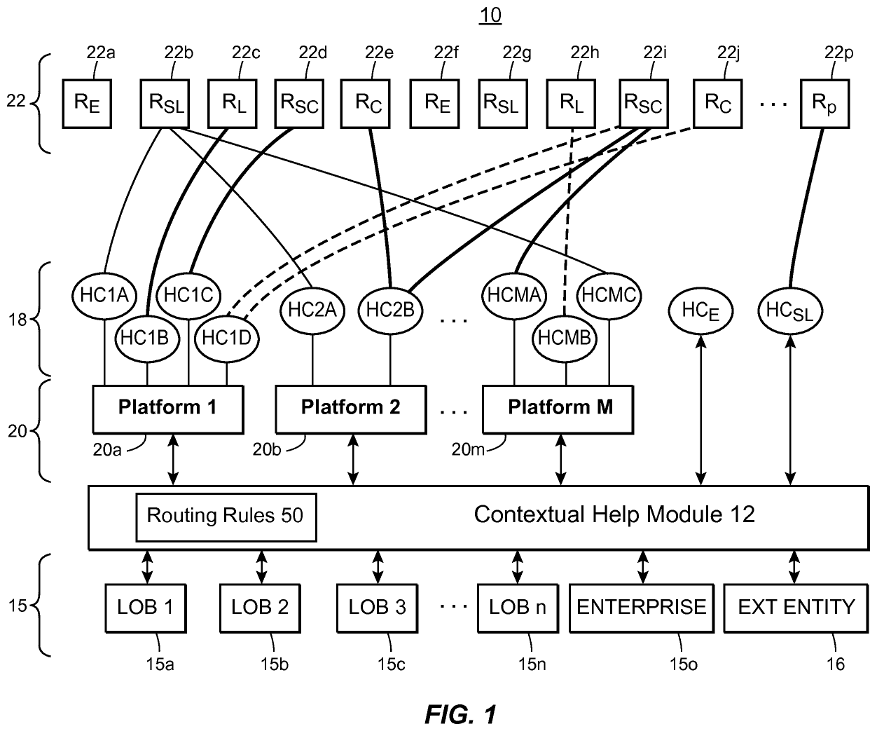

FIG. 1 is a block diagram of an exemplary system 10 that is utilized by an enterprise, also referred to interchangeably herein as an enterprise system 10. The enterprise may include multiple lines-of business (LOBs). For example, the enterprise may be an insurance and financial services company or enterprise that includes an automobile insurance LOB, a life insurance LOB, a property insurance LOB, other types of insurance LOB (e.g., health, renters, home owners, personal articles, pet, burial, or other kinds of insurance), a mutual fund investment LOB, a banking LOB, a mortgage and/or loan LOB, etc. Each of the multiple LOBs of the enterprise may provide a respective LOB-specific customer-facing process 15a-15n, such as respective sets of display views. In some cases, a general customer-facing process 15o for the enterprise as a whole may be provided. Generally, a customer-facing process 15a-15o may be a customer (or potential customer) interface or may be an agent interface that may be utilized by an agent of a LOB or of an enterprise while communicating with a customer or a potential customer.

The system 10 includes a contextual help module 12 that may comprise a single, logical, intelligent layer disposed between a plurality of customer-facing processes 15, 16 and a set of help capabilities 18 (also referred to herein as “collaboration capabilities 18”) provided by the enterprise. The contextual help module 12 may be integrated with each of multiple customer-facing processes 15 of the enterprise, e.g., onto or with various display views provided by various LOBs and by the enterprise itself, and may be configured to determine a context of a help request received at a particular display view with which the contextual help module 12 is integrated.

Based upon the determined context, the contextual help module 12 may dynamically render appropriate display view content and/or user controls that may be utilized for responding to the received help request. Additionally or alternatively, based upon the determined context, the contextual help module 12 may be configured to determine a particular help capability and/or a particular help resource to which the received help request is to be routed for servicing, e.g., a “receiving help capability,” and to route the received help request thereto. The context of the received help request may be determined by the contextual help module 12 based upon any one or more characteristics and/or parameters associated with the received help request, for example, the identity (and optionally, additional characteristics) of a particular LOB providing the customer-facing process 15 at which the help request was received, information indicative of and/or corresponding to the customer issuing the help request, information indicative of and/or corresponding to a user or help session during which the help request was received, and/or other characteristics or parameters, as will be detailed in later sections.

As such, the contextual help module 12 may be a single entity that is usable or re-usable across multiple LOBs of an enterprise, and that may provide a layer of abstraction so that various different customer-facing processes 15, 16 need not be cognizant of the various different types of platforms 20, and further need not be hard-coded or otherwise pre-programmed to be able to communicate with various different platform 20. That is, the contextual help module 12 not only may support multiple platforms onto which various help capabilities are built, but the contextual help module 12 may also shield customer-facing processes 15 from the details of supporting the multiple platforms. Consequently, by using the contextual help module 12, an enterprise may easily support and implement help capabilities (some of which may be customized) across multiple or even all of its LOBs with minimal implementation and service cost.

For example, new help capabilities may be easily adopted with minimal coding changes. Further, as the contextual help module 12 may provide a platform-agnostic integration of multiple help capabilities, supporting platforms may be easily replaced with minimal impact to the help capabilities themselves. Still further, the contextual help module 12 may allow help capabilities to have consistent behavior, look and feel across the enterprise.

With regard to the enterprise system 10 shown in FIG. 1, each of the LOB-specific customer-facing processes 15a-15n may be provided by and be customized for a respective LOB of the enterprise. Similarly, each enterprise customer-facing process 15o may be provided by and be customized for the enterprise. Each customer-facing process 15a-15o may include a direct customer (or potential customer) interface and/or an agent interface that may be utilized by an agent while communicating with a customer or a potential customer.

Each of the customer-facing processes 15a-15o may include one or more respective display views that are able to be presented on a display or screen of a stationary or mobile computing device. Instances of the various display views may be presented on a computing device operated by an agent of the enterprise, an agent of the providing LOB, or a user such as a customer or potential customer of the LOB or enterprise, and may include thereon user controls via which the operator of the computing device may interact with the display views. For example, a LOB-specific display view 15a-15n may be a website hosted by the LOB; may be provided by a server or by a plurality of host computing devices such as a computing cloud; and/or may be provided by a client or stand-alone application executing on the computing device operated by an agent of the enterprise, an agent of the LOB, or by a user such as a customer or potential customer of the LOB or enterprise.

For ease of readability, a “user” or “operator” of a customer-facing process 15a-15o as used herein generally refers to an agent of the enterprise, an agent of the LOB or enterprise, an insurance provider representative or agent, a user such as a customer or potential customer of the LOB or enterprise, or any other person who interacts with the customer-facing process 15a-15o. Additionally or alternatively, for ease of readability, the term “customer” as used herein generally refers to a customer, a client, a potential customer, or a potential client of the enterprise (such as an insurance provider, financial services provider, and/or other services or products provider) and/or of one or more particular LOBs of the enterprise.

The contextual help module 12 may be integrated with each of the customer-facing processes 15a-15o via any suitable technique or techniques. For example, integration of the contextual help module 12 and a particular display view 15a-15o may be achieved by using message exchanges, function calls, APIs (Application Programming Interfaces), and the like. In some embodiments, such as indicated in FIG. 1, the contextual help module 12 is hosted and/or executes on one or more computing devices that are separate from the computing devices on which the display views 15a-15o are hosted and/or are executing, and the integration between the contextual help module 12 and each display view 15a-15o is remotely achieved.

In some embodiments (not shown), the contextual help module 12 and a particular display view 15a-15o are locally integrated, e.g., an instance of the contextual help module 12 and the particular display view 15a-15o may execute on a same computing device or a same group of computing devices and may be in communicative connection thereon. In some embodiments, the contextual help module 12 and the display view 15 may be a single, integral entity executing on a same computing device or a same group of computing devices. Some embodiments of the system 10 (not shown) may include both locally and integrated display views 15a-15o.

In some configurations, the contextual help module 12 may be accessible to an entity that is external to the system 10, which is illustrated in FIG. 1 as external entity 16. The external entity 16 may be a customer-facing process or display view that is not provided by the enterprise of the system 10. Nonetheless, the contextual help module 12 may allow the external entity 16 to render help information and/or capabilities on its display views, and/or to route customer help requests to servicing resources, which typically (but not necessarily) are different than the resources of the system 10.

Further, the external entity 16 may or may not be in communicative connection with any portion of the system 10 other than the contextual help module 12. Indeed, in some cases, a first instance of the contextual help module 12 may service the system 10, and a second instance of the contextual help module 12 may service the external entity 16. The first and second instances of the contextual help module 12 may be common between the system 10 and the external entity 16, or the first and second instances of the contextual help module 12 may include at least some aspects that are respectively unique to the system 10 and the external entity 16. Similar to the system 10, though, the instance of the contextual help module 12 servicing the external entity 16 may be remotely and/or locally communicatively connected to the external entity 16.

The set of help capabilities 18 may include various capabilities or functions that allow a user, such as a customer or a potential customer, to obtain information about the enterprise or about a specific LOB and/or to obtain answers to any questions the user may have about the enterprise and/or about the specific LOB, and its products and services. Examples of types of help capabilities 18 may include interactive help capabilities such as a toll-free telephone number, a chat capability, an email capability, and/or a “call-back” capability that allows a user to enter contact information via which a representative of the enterprise and/or the specific LOB may utilize to contact the user at a later time.

Generally, interactive help capabilities may enable a user to communicate asynchronously or in real-time with an agent or representative of the specific LOB, and/or may enable a user to communicate asynchronously or in real-time with an agent or representative who services multiple LOBs or the entire enterprise. Other examples of types of help capabilities 18 may include presentation-only help capabilities, such as Frequently Questions (FAQs) and corresponding answers, knowledge-based articles such as instructions, user guides, product descriptions or information, directory listings, copies of regulations, etc., and/or links thereto.

Each of the help capabilities 18 may be supported by a respective platform 20a-20m. In some cases, one or more platforms 20a-20m may be procured by the enterprise or by a particular LOB from one or more vendors or third parties, e.g., one or more “vendor platforms.” In some cases, though, one or more of the platforms 20a-20m may be provided by the enterprise or by a particular LOB of the enterprise. For example, the platform 20m may be a platform that is internally developed, implemented, and maintained by the enterprise or by a particular LOB of the enterprise.

Platforms 20a-20m may support one or more desired, customized enterprise- and/or LOB-specific help capabilities 18, and as such, enterprise- and/or LOB-specific help capabilities 18 may be built on top of or otherwise supported by platforms 20a-20m. Examples of vendor platforms 20a-20m which are able to support enterprise- and/or LOB-specific help capabilities 18 may include general help capability platforms such as a chat capability platform, a call-back capability platform, etc. that are provided by third-party companies, such as Oracle, eGain, or other software providers.

Accordingly, the contextual help module 12 may be in communicative connection with each of the platforms 20a-20m utilized by the enterprise and/or by its LOBs, e.g., as shown in FIG. 1. That is, the contextual help module 12 may be cognizant of and may utilize the particular syntaxes, APIs, function calls, and/or other hooks or connections needed to communicate with each different platform 20a-20m.

As illustrated in FIG. 1, each platform 20a-20m may support one or more different help capabilities 18, which are individually denoted by the labeled circles HCXY, where X indicates a particular platform and Y indicates a particular help capability supported by the particular platform. In some configurations, a same type of help capability 18 may be provided by different platforms 20a-20m. For example, the help capability HC2B may be a real-time chat capability supported by the platform of Vendor 2 (reference 20b), and the help capability HC1D may also be a real-time chat capability even though it is supported by a platform of a different vendor, e.g., Vendor 1 (reference 20a).

In some configurations, the system 10 may include one or more enterprise or enterprise-wide help capabilities HC_{E}. An enterprise-wide help capability HC_{E} may be utilized by any LOB of the enterprise. Additionally or alternatively, the system 10 may include one or more help capabilities HC_{SL} that may be used by multiple (but not all) LOBs of the enterprise. In FIG. 1, the help capabilities HC_{E}, HC_{SL} are illustrated as being stand-alone capabilities that are not built on any platform 20 and that are directly accessible by the contextual help module 12. However, while not specifically labeled as such in FIG. 1, one or more enterprise-wide help capabilities HC_{E} and/or one or more shared help capabilities HC_{SL} need not to be stand-alone capabilities and may be implemented on any desired platform 20.

Similarly, in some configurations, the system 10 may include one or more help capabilities (not labeled in FIG. 1) that are unique or particular to a single LOB. LOB-specific help capabilities each may be a stand-alone help capability or may be supported by a platform 20.

Although FIG. 1 depicts the Platform 1 as supporting four capabilities HC1A, HC1B, HC1C, and HC1D; Platform 2 as supporting two capabilities HC2A and HC2B; and Platform m as supporting three capabilities HCMA, HCMB, and HCMC, it is understood that each of the platforms 20a-20m may support any number of capabilities. For example, the platform 20a may support zero, one, two, three, or more than four capabilities HC1Y, the platform 20m may support zero, one, or more than three capabilities HCMY, etc.

The system 10 may include a plurality of resources 22a-22p that may be utilized to implement the help capabilities 18. Each help capability 18 may access one or more resources 22 by using any suitable or desired access mechanism or communicative connection, for example, by using a message exchange over one or more communication links, function calls, APIs (Application Programming Interfaces), etc. Indeed, any number of any suitable or desired communication technologies may be utilized by each help capability 18 to access one or more resources 22.

The plurality of resources 22a-22p may include one or more static resources. As referred to herein, “static” resources generally include content that is for viewing or unidirectional consumption by a user, and may be utilized by both interactive and presentation-only help capabilities 18. Examples of static resources may include data files that contain or store knowledge-based articles such as instructions, user guides, product descriptions or information, directory listings, copies of regulations, toll-free telephone numbers and/or other contact information, etc. The enterprise or LOB may occasionally change or update the content of static resources, however, the content of static resources generally remains constant or static while being viewed or consumed by a user. For example, a particular platform 20 may allow sets of FAQs and corresponding answers to be created, stored, and updated.

The plurality of resources 22a-22p may include one or more resources that enable interactive help capabilities such as a chat capability, an email capability, a call-back capability, etc. to be provided. Generally, resources that are utilized for implementing interactive help capabilities may be applications or other suitable executable entities that link a particular customer session, user session, or help session of a specific customer-facing process 15a-15o with an application or program executing on a computing device that is being operated by a representative or agent who is associated with the enterprise or a particular LOB of the enterprise. As referred to herein, a “customer interaction session,” “customer session,” “user session,” “help session,” “customer help session,” or “session” refers to a period of time, workflow, or thread during which a customer's help request is serviced, e.g., a time period, workflow, or thread during which a customer or agent interfaces with a customer-facing process 15a-15o to obtain or to attempt to obtain the information that the customer desires.

Typically, a customer interaction or help session may be initiated when an indication of a customer's initial request for help is received at a display view 15a-15o with which the contextual help module 12 is integrated, e.g., via a user control corresponding to the contextual help module 12. The customer interaction or help session may terminate when the customer so indicates, e.g., after he or she has received the desired answer or information, has moved on to some other area of the display view 15a-15o, has terminated the contextual help module 12, has exited from the display view 15a-15o, etc.

In some scenarios, a customer interaction or help session may be noncontiguous over time, such as when a customer requests a call-back and an agent or representative contacts the customer at a later time. In some scenarios, a customer interaction or help session may include the entirety of a contiguous period of time, such as when the customer and an agent or representative communicates via a real-time chat capability. In these scenarios, a customer interaction or help session may include the entirety of a logical, communication protocol session established between the respective applications utilized by the computing device of the customer and by the computing device of a responding agent or representative.

In some embodiments, a particular resource 22a-22p may support or may be shared across multiple capabilities 18 and/or multiple LOBs. For example, a call center personnel resource 22b may be utilized by or may provide support for the capabilities HC1A, HC2A and HCMC, so that a same pool of call-center responders may support call-back capabilities that are built on different platforms 20 and that may service any number of different LOBs. In another example, the resource 22i may be utilized by or provided to multiple, different types of capabilities HC1D, HC2B and HCMA. For instance, the resource 22i may be a script for real-time chat and real-time toll-free call responders to follow when communicating in real-time with customers.

In some cases, multiple resources 22 may be utilized to implement a single capability 18. For example, a real-time chat capability HC2B may utilize a set or bank of chat responders 22e (e.g., staff that are available to answer chat requests) as well as a static resource 22i that provides a script for the chat responders to follow while addressing customer questions.

The plurality of resources 22 may include one or more resources that may be shared across all LOBs of the enterprise, examples of which are denoted in FIG. 1 by the label R_{E}. For example, the enterprise-wide resource 22a may be a data file storing contact information for officers, board members, and headquarters of the enterprise and, although not depicted in FIG. 1 for clarity's sake, each enterprise-wide resource R_{E} may be accessed by each of the capabilities 18 of the system 10.

Additionally or alternatively, the plurality of resources 22 may include one or more resources that may be shared across multiple (but not all) LOBs of the enterprise. Examples of such resources are denoted in FIG. 1 by the label R_{SL}. For example, the resource 22b may include a call center that is utilized in a call-back capability HC1A which may be used by two different lines-of-business, e.g., LOB 1 (reference 15a) and LOB 3 (reference 15c).

Additionally or alternatively, the call center resource 22b may be utilized by different call-back capabilities built on different platforms used by different LOBs, e.g., HC2A may be a call-back capability used by LOB 2 (reference 15b) and HCMC may be a call-back capability used by LOBn (reference 15n). Still additionally or alternatively, the plurality of resources 22 may include one or more resources that are unique to a particular LOB, examples of which are denoted in FIG. 1 by the label R_{L}. For example, the resource 22c may be used by a switchboard/voicemail capability HC1B for routing help requests to agents of a particular LOB 15c.

As previously discussed, one or more resources 22 may support or be shared by multiple capabilities of the enterprise. Such resources are denoted in FIG. 1 by the label R_{SC}. For example, the resource 22i may be a script that is shared by the chat capabilities HC1D and HC2B and by a toll-free number capability HCMA so that different types of real-time, interactive responders of the enterprise are able to utilize a common script 22i when addressing real-time customer questions. In another example, the resource 22d may include a group of responders who service email help requests for one or more LOBs of the enterprise, e.g., via the email capability HC1C.

Additionally or alternatively, the plurality of resources 22 may include one or more resources that are unique to a particular capability, which are denoted in FIG. 1 by the label R_{C}. For example, the resource 22j may include a data file for each agent of a particular LOB 15c in which the agent's contact information is stored, and which may be utilized by all help capabilities that are available to the LOB 15c (not shown).

Although FIG. 1 illustrates only two instances of each type of resource R_{E}, R_{SL}, R_{L}, R_{SC}, R_{C}, it is understood that the system 10 may include any number of each of the types of resources R_{E}, R_{SL}, R_{L}, R_{SC}, R_{C}. For example, the system 10 may include zero, one, two or multiple enterprise resources R_{E}, the system 10 may include zero, one, two or more resources R_{SL} that are shared across LOBs, the system 10 may include zero, one, two or more resources that are particular to a specific capability R_{C}, etc.

### III. Exemplary Contextual Help Module

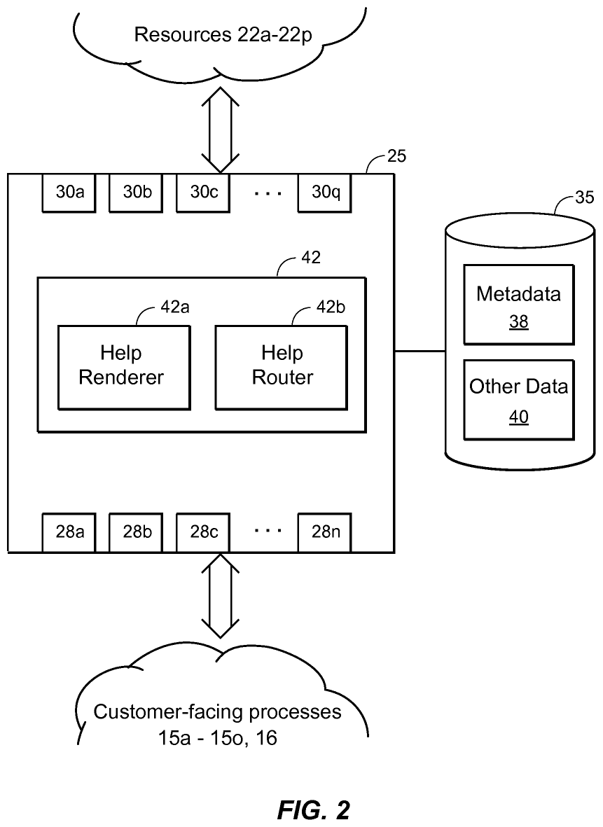

FIG. 2 includes a detailed block diagram of a contextual help module 25, which may be included in the system 10 (e.g., as part or all of the contextual help module 12), or may be utilized in systems other than the system 10. For ease of discussion and not for limitation purposes, though, the contextual help module 25 is described below with simultaneous reference to the system 10 of FIG. 1.

The contextual help module 25 may include a plurality of ports 28a-28n, each of which may be communicatively connected to a respective customer-facing process 15a-15o, such as a display view or other application. As previously discussed, the communicative connections between the contextual help module 25 and the customer-facing processes 15a-15o, and thereby the ports 28a-28n, may use any one or more suitable communication technologies, such as message exchanges over one or more communication links, function calls, APIs (Application Programming Interfaces), etc. The ports 28a-28n may include mutually exclusive sets of unidirectional input ports and unidirectional output ports, and/or the ports 28a-28n may include at least some bi-directional input/output (I/O) ports. The ports 28a-28n may include any number of physical and/or logical ports.

Similarly, the contextual help module 25 may include may include a plurality of ports 30a-30q, each of which may be communicatively connected to one or more different platforms 20a-20m, and thereby may be communicatively connected to the set of capabilities HCXY18 respectively supported by each platform 20a-20m. Additionally, the contextual help module 25 may be communicatively connected, via the ports 30a-30q, to any stand-alone help capabilities (e.g., HC_{E}, HC_{SL}, etc.) provided by the system 10. The communicative connections provided by the ports 30a-30q may use any one or more suitable communication technologies, such as message exchanges over one or more communication links, function calls, APIs (Application Programming Interfaces), etc. The ports 30a-30q may include mutually exclusive sets of input ports and output ports (e.g., mutually exclusive sets of inputs and outputs), and/or the ports 30a-30q may include at least some bi-directional input/output (I/O) ports. The ports 30a-30q may include any number of physical and/or logical ports.

The contextual help module 25 may be communicatively connected to and/or may be adapted to access one or more data storage devices or entities 35. The one or more data storage entities 35 may comprise, for example, one or more memory devices, a data bank, cloud data storage, and/or one or more other suitable data storage devices. Indeed, the one or more data storage entities 35 may include one physical device, or the one or more data or memory storage entities 35 may include more than one physical device. In any case, the one or more data storage entities 35, though, may logically appear as a single data storage device or entity irrespective of the number of physical devices included therein. Accordingly, for ease of discussion only and not for limitation purposes, the data storage device or entity 35 is referred to herein using the singular tense.

The data or memory storage device 35 may be configured and/or adapted to store metadata 38 and other data 40 related to the system 10. In an embodiment, the data storage device 35 may store metadata 38 that is indicative of subscriptions, to the contextual help module 25. A subscription of an entity to the contextual help module 25 may allow the subscribing entity to utilize or rely on the contextual help module 25 to render entity-specific help information and/or indications of available help capabilities for the subscribing entity on a display view provided by the subscribing entity.

Additionally or alternatively, a subscription of an entity may allow the subscribing entity to utilize or rely on the contextual help module 25 to route a customer's help request to one or more appropriate resources 22 to service the help request. An individual LOB may be a subscriber of the contextual help module, a group of LOBs may be a subscriber, the enterprise as a whole may be a subscriber, and an external entity or group of external entities may be a subscriber of the contextual help module.

In addition to indications of subscriptions, the metadata 38 may include indications of help capabilities 18 and parameters related thereto. For example, the metadata 38 may include an indication of a respective set of capabilities 18 that are provided for a particular subscribing entity, e.g., the set of help capabilities 18 to which a particular LOB has subscribed. Additionally or alternatively, the metadata 38 may include an indication of a respective set of capabilities 18 that are supported by a particular resource 22a-22p.

In some cases, the metadata 38 may include indications of one or more characteristics or parameters corresponding to one or more help capabilities 18. For example, for a particular resource 22, the metadata 38 may indicate a set of help capability types (chat, email, callback, etc.) that are supported by the particular resource. The metadata 38 may indicate one or more specific capabilities (e.g., HCXY) that are supported and/or provided by a particular platform 20. The metadata 38 may include other indications of characteristics or parameters corresponding to each of at least some of the help capabilities 18, such as respective connection information (e.g., to one or more particular platforms 20, a type of connection, etc.); respective hours of operation, a respective availability state or condition that may determine availability, a respective language utilized (e.g., English, Spanish, etc.), and/or a priority of a particular capability (e.g., with respect to at least one other capability), to name a few.

In some configurations, the metadata 38 may include indications of particular information or data corresponding to and/or received in conjunction with a customer help request or customer help session that is to be rendered or and/or routed for a particular resource, capability, and/or LOB. For example, indications that a customer name, an indication of a state, province or other geographical location corresponding the customer, customer contact information, and/or any other information that may be obtained by the display view (either by direct user input or implicitly) is to be rendered and/or routed may be included in the metadata 38.

Additionally or alternatively, the data storage entity 35 may include other data 40 that is not metadata. For example, text that is to be rendered by the contextual help module 25 in conjunction with a particular display view provided by a particular subscribing entity may be stored as data 40 in the data storage entity 35. In another example, respective logos and copyright information of various LOBs may be stored as data 40. In yet another example, particular frames, display screen locations, and/or configurations of user controls desired by a particular LOB or desired by the enterprise may be stored as data 40. The data 40 may include data corresponding to or indicative of one or more capabilities and/or of one or more subscribing entities 15a-15o, 16.

The contextual help module 25 may include one or more sets of computer-executable instructions 42 that are stored on one or more memories, data storage devices, or non-transitory, tangible computer-readable media, and/or that are executable by one or more processors.

### IV. Exemplary Method for Contextual Help Rendering

One example set of instructions 42 which may be included in the contextual help module 25 is the Help Renderer 42a. The computer-executable instructions comprising the Help Renderer 42a, when executed by one or more processors, may cause the contextual help module 25 to render, on a display view or in conjunction with the display view, entity-specific help information and/or capabilities corresponding to the particular entity providing the display view. At least some of the entity-specific help information and/or capabilities may be seamlessly integrated into the display view, and/or at least some other of the entity-specific help information and/or capabilities may be presented in another window (e.g., a pop-up window) or in another distinct area of the screen.

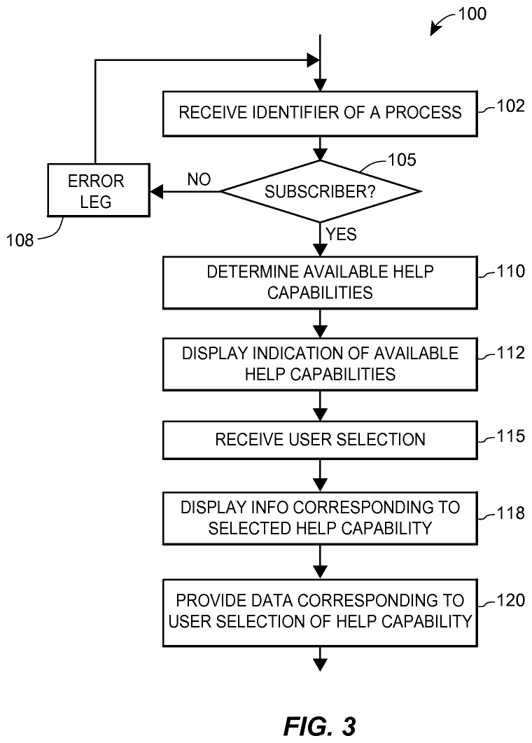

In particular, the computer-executable instructions comprising the Help Renderer 42a may be executable to perform at least a portion of the method 100 for contextual help rendering illustrated in FIG. 3. In some embodiments, at least a portion of the method 100 may be performed by the contextual help module 25, and as such, the method 100 is described below with simultaneous reference to FIGS. 1 and 2. However, it is understood that embodiments of the method 100 may be utilized in systems other than the system 10 of FIG. 1, and/or may be performed by other entities other than the contextual help module 25 of FIGS. 1 and 2.

In FIG. 3, at a block 102, the method 100 may include receiving an identifier of an entity that has received an indication that a customer desires to obtain help, e.g., a customer help request. In an embodiment, the identifier or indication of the help request-receiving entity may be received (block 102) at a contextual help module 12. As discussed with respect to FIGS. 1 and 2, the help request-receiving entity may provide or may be a customer-facing process 15a-15o or an external entity customer-facing process 16 into or with which the contextual help module 25 is integrated and via which the customer help request is received. For example, the help request may be received via a display view on which a hook or connection to the contextual help module 25 is established when a user activates a particular user control thereon, such as a help icon.

For ease of discussion, but not for limitation purposes, the method 100 is discussed with respect to a display view provided by an entity (e.g., a particular LOB, the enterprise, or an external entity) on which a user has activated the particular user control via which the contextual help module 25 is accessed or invoked. For example, a customer or agent of a particular LOB may have clicked on or otherwise activated a help icon or other help indicator associated with a display view, an identification of a particular entity associated with the user help request may be determined, and a resulting indication or identifier of the entity may be received by the method 100 (block 102).

The identifier or indication of the entity may be determined based upon the display view into which the contextual help module 25 is integrated, either automatically and/or based upon information that is manually entered by the user. For example, the display view or the contextual help module 25 may automatically determine the identifier or indication of the particular entity based upon data that is accessible to the display view, or a user may enter an indication of a particular entity for which he or she desires information.

In some cases, the indicated entity may be a subscribing entity of the contextual help module 25. For example, the identifier of the help request-receiving entity may be a subscriber ID of the entity. In another example, the identifier of the help request-receiving entity may indicate that a group of LOBs to which the entity belongs has a subscription to the potential help module 25, e.g., the identifier of the help request-receiving entity may be a subscriber ID of a subscribing group of LOBs.

Based upon the identifier or identification of the help request-receiving entity, the method 100 may determine whether or not the entity is, or is affiliated with, a valid subscription of the contextual help module (block 105). In an example, the determination of whether or not the entity is, or is affiliated with, a valid subscription may be based upon the metadata 38 that is accessible to the Help Renderer 42a, e.g., the metadata 38 may indicate entities that have subscriptions to the contextual help module 25, and whether those subscriptions are current, expired, etc.

If the method 100 determines at the block 105 that the help request-receiving entity is not affiliated with a valid subscription (e.g., the subscription identifier or ID is invalid, the subscription has lapsed, etc.), the method 100 may return a corresponding indication such as an error code or similar, an indication of which may be presented on the display view (block 108). The method 100 may then return to await the reception of an identifier of another entity at which another help request was received (block 102).

On the other hand, if the method 100 determines at the block 105 that the subscription is valid and in force, the method 100 may determine a set of available help capabilities based upon the subscriber ID (block 110). The set of available help capabilities may include a set of help capabilities that are provided for the entity and that are available at the time of the received help request (e.g., the request is received during specified hours of operation, the communicative connections to the capabilities are available, etc.).

The set of available capabilities may be determined (block 110) based upon the metadata 38 and/or based upon other data such as real-time status data. For example, the metadata 38 may indicate a respective set of help capabilities that is provided by the indicated subscription, and the real-time status data may indicate whether or not each of the members of the respective set is currently available. Upon determination of the available help capabilities (block 110), the method 100 may include providing respective indications of the available help capabilities (block 112), for example, on the display view which the help request was received, or on a pop-up window or other viewing area presented in conjunction with the display view. In one embodiment, the respective indications of the available help capabilities may include respective user-activated controls.

In some embodiments, indications of help capabilities that are provided by the indicated subscription but that are currently unavailable may also be presented in conjunction with the indications of the available help capabilities (block 112). For example, if the help request is received (block 102) at a time when a call center is unavailable, such an indication may be presented along with a listing of the hours during which the call center is available.

At a block 115, the method 100 may include receiving an indication of a user selection of one of the available help capabilities. For example, an indication of an activation of a user control indicative of a particular help capability may be received (block 115).

At a block 118, the method 100 may include providing information and/or data corresponding to the selected help capability for presentation on the display view, or in a pop-up window or other viewing area that corresponds to the contextual help module 25 and that is presented in conjunction with the display view. In some situations, the provided information corresponding to the selected help capability may be a static resource, such as contact information or a set of FAQs. In some situations, the provided information corresponding to the selected help capability may be interactive. For example, the provided information may include one or more user controls, such as an email template, a chat screen, or other mechanism that allows for interaction between the user and a help resource 22.

In some embodiments of the method 100, other information in addition to the identifier of the particular LOB may be received at the block 102. The additional information may be utilized in conjunction with the LOB identifier to determine the set of available help capabilities (block 110). For example, if an indication of a particular agent who has a relationship with the customer is received at the block 102, the block 110 may include, in the set of available help capabilities, a capability to perform a real-time chat with the particular agent when he or she is available, and/or may exclude such a capability from the set of available help capabilities when the particular agent is unavailable to chat.

The additional information received at the block 102 may be utilized to customize the presentations of the indications of the available help capabilities (block 112). For example, the indications of the available help capabilities may be customized to include the customer name, his or her agent's name and contact information (if the customer has such an established relationship with an agent), and the like. Similarly, the additional information received block at the 102 may be utilized to customize the information or data corresponding to the selected help capability that is presented on the display view (block 118). For example, the format and or content of the information corresponding to the selected help capability may be customized based upon the state, province, and/or other geographical location indicated in the additional information received at the block 102.

In some embodiments, the method 100 may include an optional block 120. The block 120 may include providing data corresponding to or indicative of the user selection of the selected help capability e.g., to one or more other blocks of the method 100, to the entity that is the subject of the help request, and/or to the enterprise.

For example, the enterprise or a particular LOB may, based upon information or data obtained via the block 120, collect statistics on how many help requests are received, the distribution of received help requests over time, the particular display views via which these help requests were received, etc. Such statistical data may be utilized to refine types of help capabilities that are provided, when certain capabilities are available or unavailable, manage resources, and the like.

In another example, a particular LOB may, based upon information or data obtained via the block 120, determine the identity of the requesting user, whether he or she is a current customer or not, and/or determine an appropriate agent to indicate or refer to the question user. Additionally or alternatively, in some cases, the block 120 may include providing the information received at the block 102 to one or more other blocks of the method 100, e.g., such as previously discussed with respect to the blocks 112 and 118.

### V. Exemplary Method for Contextual Help Routing

Returning now to FIG. 2, an example of a set of instructions 42 which may be included in the contextual help module 25 may be the Help Router 42b. The computer-executable instructions comprising the Help Router 42b, when executed by one or more processors, may cause the contextual help module 25 to route a customer help request to a particular help capability 18 and/or to a particular help resource 22.

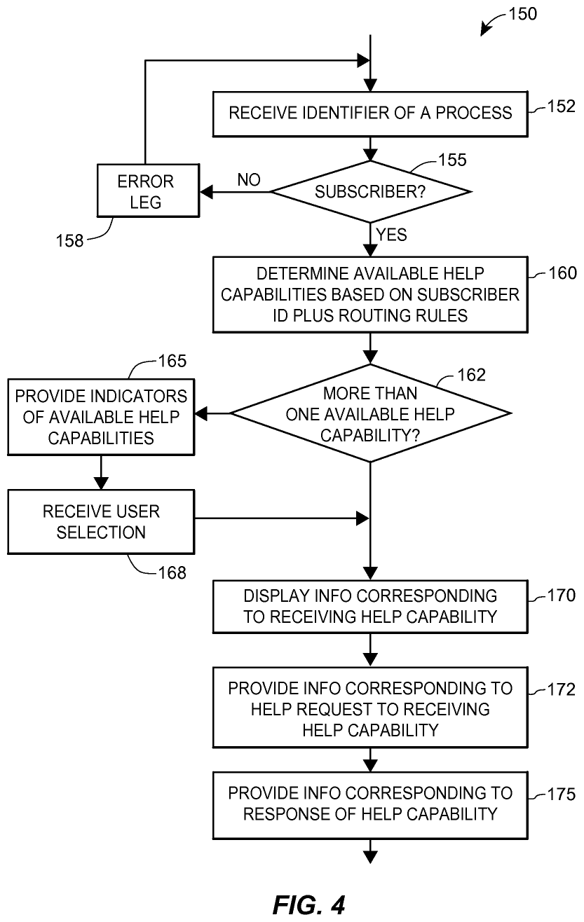

Specifically, the computer-executable instructions comprising the Help Router 42b may be executable to perform at least a portion of the method 150 for contextual help routing illustrated in FIG. 4. In some embodiments, at least a portion of the method 150 may be performed by the contextual help module 25, and as such, the method 150 is described below with simultaneous reference to FIGS. 1 and 2. However, it is understood that embodiments of the method 150 may be utilized in systems other than the system 10 of FIG. 1, and/or may be performed by other entities other than the contextual help module 25 of FIGS. 1 and 2.

In FIG. 4, at a block 152, the method 150 may include receiving an identifier of an entity that has received an indication that a customer desires to obtain help, e.g., a customer help request. In an embodiment, the identifier or indication of the help request-receiving entity may be received (block 152) at a contextual help module

As discussed with respect to FIGS. 1 and 2, the help request-receiving entity may provide or may be a customer-facing process 15a-15o or an external entity customer-facing process 16 into or with which the contextual help module 25 is integrated and via which the customer help request is received. For example, the help request may be received via a display view on which a hook or connection to the contextual help module 25 is established when a user activates a particular user control thereon, such as a help icon.

For ease of discussion, but not for limitation purposes, the method 150 is discussed with respect to a display view provided by an entity (e.g., a particular LOB, the enterprise, or an external entity) on which a user has activated the particular user control via which the contextual help module 25 is accessed or invoked. For example, a customer or agent of a particular LOB may have clicked on or otherwise activated a help icon or other help indicator associated with a display view, an identification of a particular entity associated with the user help request may be determined, and/or a resulting indication or identifier of the entity may be received by the method 150 (block 102).

The identifier or indication of the entity may be determined based upon the display view into which the contextual help module 25 is integrated, either automatically and/or based upon information that is manually entered by the user. For example, the display view or the contextual help module 25 may automatically determine the identifier or indication of the particular entity based upon data that is accessible to the display view, and/or a user may enter an indication of a particular entity for which he or she desires information.

In some cases, the indicated entity may be a subscribing entity of the contextual help module 25. For example, the identifier of the help request-receiving entity may be a subscriber ID of the entity. In another example, the identifier of the help request-receiving entity may indicate that a group of LOBs to which the entity belongs has a subscription to the potential help module 25, e.g., the identifier of the help request-receiving entity may be a subscriber ID of a subscribing group of LOBs.

Based upon the identifier or identification of the help request-receiving entity, the method 150 may determine whether or not the entity is, or is affiliated with, a valid subscription of the contextual help module (block 155). In an example, the determination of whether or not the entity is, or is affiliated with, a valid subscription may be based upon the metadata 38 that is accessible to the Help Router 42b, e.g., the metadata 38 may indicate entities that have subscriptions to the contextual help module 25, and/or whether those subscriptions are current, expired, etc.

If the method 150 determines at the block 155 that the help request-receiving entity is not affiliated with a valid subscription (e.g., the subscription identifier or ID is invalid, the subscription has lapsed, etc.), the method 150 may return a corresponding indication, such as an error code or similar indication of which that may be presented on the display view (block 158). The method 150 may then return to await the reception of an identifier of another entity at which another help request was received (block 152).

On the other hand, if the method 150 determines at the block 155 that the subscription is valid and in force, the method 150 may determine a set of respective available capabilities based upon the subscriber ID and a set of routing rules (block 160), which is depicted in FIG. 1 by the reference 50. The set of available capabilities may be at least partially determined (block 160) based upon the metadata 38. For example, the metadata 38 may indicate a respective set of help capabilities that is provided by the indicated subscription. The set of routing rules 50 may further refine the members of the respective set of help capabilities corresponding to the subscription to determine the available set of help capabilities corresponding to the subscription. In one embodiment, the set of routing rules 50 may include one or more rules based upon one or more routing criteria, some of which may be defined or indicated by the enterprise and/or some of which may be defined by a particular LOB or a particular group of LOBs. The current routing criteria corresponding to one or more routing rules 50 may be determined, and the one or more routing rules 50 may be applied to the current routing criteria to determine whether or not subscribed-to capabilities may be utilized and/or accessed by the requesting entity.

Some of the routing criteria may pertain to a capability availability, e.g., a respective capacity of a capability, an availability of a respective communicative connection via which the capability is accessed (such as a network and/or a link availability), the hours of operation during which a capability is available, and other criteria indicative of whether or not the capability is available. An example routing rule based upon routing criteria pertaining to capability availability may be “route help request to and/or indicate a particular capability is available when all respective capability availability routing criteria indicate as such, and if at least one availability routing criteria indicates that the particular capability is not available, route the help request to a particular static help capability.”

In some cases, some of the routing criteria may pertain to characteristics of the capability, for example, a type of the capability (e.g., static or interactive, real-time or asynchronous, chat, email, telephone, data file, etc.) and/or to a priority of the capability with respect to other capabilities. For example, to service a received help request, the routing rules 50 (as implemented based upon the capability characteristic routing criteria) may indicate that an interactive, real-time help capability, such as a real-time chat capability has a highest priority. However, if the highest priority capability is unavailable, the determination of an alternate receiving help capability and the routing of the received help request thereto may be based upon a prioritized list of other capabilities and their respective availabilities, e.g., a second priority may be an interactive, asynchronous help capability, such as an email exchange or a call back, and a third priority may be a presentation of a set of FAQs.

Additionally or alternatively, some of the routing criteria may be based upon organizational criteria. For example, different LOBs, different sub-lines-of business of a particular LOB (e.g., Sub-LOBs), and/or different functional areas of a particular LOB may each support different sets of capability types, different priority routing lists, different hours of operations for a particular capability, and the like.

Still additionally or alternatively, some of the routing criteria may be based upon the user. For example, one or more routing criteria may be based upon a received user selection, e.g., the user has indicated that he or she would prefer to use an email help capability, the user has indicated that he or she is seeking information about a specific product or service, the user has indicated that he or she would like to communicate in Spanish, etc. In some situations, a desired language may be obtained without explicit user indication, e.g., the desired language may be determined from the display view on which the contextual help module 25 is integrated. Some of the routing criteria may be based upon a geographical location of the user, such as a state, provincial or other jurisdiction, a city or other sales territory that is serviced by a particular office or agent of a particular LOB or of the enterprise, etc. The geographical location of the user may be determined via explicit information that is entered by the user on the display view, or that is provided by the user to the contextual help module 25, or the geographical location may be implicitly determined by the display view or by the contextual help module 25, e.g., based upon an IP (Internet Protocol) address or other information associated with the display view.

Similarly, other information indicative of the user may be used as routing criteria. For example, a user's age, home address, selection of a particular help topic, indication of an agent with whom he or she has a relationship, established customer record, etc. may be used as routing criteria. The information indicative of the user may be explicitly provided by the user at the display view or to the contextual help module 25, or at least some of the information may be obtained from the display view or from the particular LOB providing the display view.

In some situations, the one or more routing criteria may be based upon information associated with display view itself. In one embodiment, a routing criterion may be an elapsed time between user interactions on the portion of the display by the contextual help module 25. For example, if a real-time chat window was provided by the contextual help module 25, and a user has not entered any information into the chat window for X minutes, the routing rules 50 may indicate that the user's help request is to be routed to an email capability, to a call back capability, and/or to a set of FAQs.

In one embodiment, one or more routing criteria may be based upon a display type and/or a device type on which the display view (and therefore the contextual help module 25 rendering(s)) is presented. The term “device type,” as used herein, generally refers to a type of device on which a display view is presented, e.g., a mobile device (such as a laptop computer, mobile telephone, smart device, tablet, phablet, smart phone, smart glasses, smart bracelet, wearable electronics, PDA (personal digital assistant), pager, etc.), personal computer, and/or other computing device. The term “display type,” as used herein, generally refers to how a display view is presented on a device, e.g., as a pop-up window, a full-screen view, etc., and/or the technology or technologies via which the display view is presented, e.g., HTML, media, fields, taxonomy, etc. Different display types and/or device types may influence the routing of a particular help request. For example, if the contextual help module 25 is integrated into a display view that is presented on a mobile telephone, a toll-free number capability and/or a call back capability may have a higher routing priority than when the same display view is presented on a desktop computer.

Of course, the routing criteria are not limited to the examples discussed above. Any one or more desired routing criteria may be additionally or alternatively incorporated into one or more routing rules 50. Further, one or more respective values of one or more particular routing criteria may be determined by the display view provided by the particular LOB and made available to the contextual help module 25 integrated with the display view. Additionally or alternatively, one or more values of one or more particular routing criteria may be determined by the contextual help module 25. The values may be determined by based upon explicit user input, or may be implicitly determined based upon data associated with the contextual help module 25, the display view, the providing LOB, the enterprise, and/or the user. For example, a value of a routing criterion may be determined based upon data gathered during a customer help session during which the help request was received, and/or based upon data gathered the user was interacting with some other portion of the display view.

Still further, in some configurations, at least some of the routing criteria and/or at least some of the routing rules 50 may be defined by the enterprise, and/or at least some of the routing criteria and/or rules 50 may be defined by a particular LOB or by a particular group of LOBs. Similarly, at least some of the routing criteria may be defined by the enterprise, and/or at least some of the routing criteria may be defined by a particular LOB, by a particular group of LOBs, and/or by an external entity.

It is noted that while FIG. 1 depicts the set of routing rules 50 as being included in the contextual help module 25, in some embodiments, the set of routing rules 50 may separate from but accessible to the contextual help module 25, e.g., by remote or local access. In some embodiments, at least a first portion of the routing rules 50 may be included in the contextual help module 25, at least a second portion of the routing rules 50 may be locally accessed by the contextual help module 25, and/or at least a third portion of the routing rules 50 may be remotely accessed by the contextual help module 50. In some embodiments, at least a portion of the routing rules 50 may be shared by multiple instances of the contextual help module 25.

Word the set of routing rules 50 may comprise any suitable format or mechanism by which rules may be indicated or represented, e.g., databases, data structures, flags, bit masks, decision trees, etc. Further, the set of routing rules 50 may be accessed (e.g., by the contextual help module 25) by utilizing any suitable access mechanism, such as an API, function call, message exchange, etc.

Returning now to the method 150, the set of available capabilities may be determined (block 160) based upon the set of routing rules 50, the metadata 38 and optionally on other data such as real-time status data of at least some of the capabilities 18, the resources 22, and/or the links providing access thereto. If the set of available capabilities includes more than one available capability as determined at the block 162, the method 150 may include providing respective indications of the available help capabilities (block 165), for example, for integrated display on the display view provided by the particular LOB, or on a pop-up window or other viewing area presented in conjunction with the display view provided by the particular LOB. The respective indications of the available help capabilities may include respective user-activated controls, in an embodiment.

In some embodiments, indications of currently unavailable help capabilities may also be presented in conjunction with the indications of the available help capabilities (block 165). For example, if the help request is received (block 152) at a time when a call center is unavailable, such an indication may be presented along with a listing of the hours during which the call center is available.

Subsequently, at a block 168, the method 150 may include receiving an indication of a user selection of one of the multiple available help capabilities. For example, an indication of an activation of a user control indicative of a particular help capability may be received (block 168).

In some scenarios, only a single help capability may be determined at the block 160 and in these scenarios, the method 150 may proceed from the block 160 to the “no” leg of block 162, and then directly to the block 170. The particular help capability that is determined at the block 160 or that is selected by the user at the block 168 is generally referred to herein as “a receiving help capability,” as it is the particular help capability that receives the user request for servicing.

At a block 170, the method 150 may include providing information and/or data corresponding to the receiving help capability for presentation on the display view provided by the particular LOB, or in a pop-up window or other viewing area corresponding to the contextual help module 25 and presented in conjunction with the display view provided by the particular LOB. In some situations, the provided information corresponding to the selected help capability may be a static resource, such as contact information or a set of FAQs. In some situations, the provided information corresponding to the selected help capability may include user controls, such as an email template that may be filled in by the user, a chat screen, or other mechanism that allows for interaction between the user and a help resource 22.

At a block 172, the method 150 may include providing, to the receiving help capability, information and/or data corresponding to the user request and/or to the customer help session in which the user request is included. For example, any of the information or data that was explicitly provided by the user or that was implicitly and/or automatically determined by the display view and/or by the contextual help module 25 may be provided to the receiving help capability.

At a block 175, the method 150 may include presenting, on the display view provided by the particular LOB or in a another viewing area corresponding to the contextual help module 25 integrated with the display view, information or data that was generated by the receiving help capability in response to receiving the data or information that was provided by the method 150 at the block 172. For example, if, at the block 172, an indication of an implicitly-determined geographical location of the user is provided to the receiving help capability, then at the block 175, information corresponding to agents that service the user's geographic location may be presented on the display view. In another example, if the user enters a question in a chat capability window at the block 172, then, at the block 175, a response from a chat responder may be presented.

It is noted that in some embodiments of the method 150, the order of the blocks 170 and 172 may be reversed from that shown in FIG. 4, e.g., the block 172 may be executed before the block 170. In such embodiments, the blocks 170 and 175 may be an integral block of the method 150.

In some embodiments, at least some portions of the method 150 may be operated in conjunction with the method 100, and vice versa. For example, at least some portions of the method 150 may be initiated or performed after execution of the block 115, the block 118, or the block 120 of the method 100. Additionally or alternatively, the methods 100 and 150 may be at least partially integrated. For example, the block 102 of the method 100 and the block 152 of the method 150 may be a same or integral block, the blocks 105 and 155 may be a same or integral block, and/or the blocks 108 and 158 may be the same or integral block.

### VI. Exemplary Enterprise System Having a Contextual Help Module

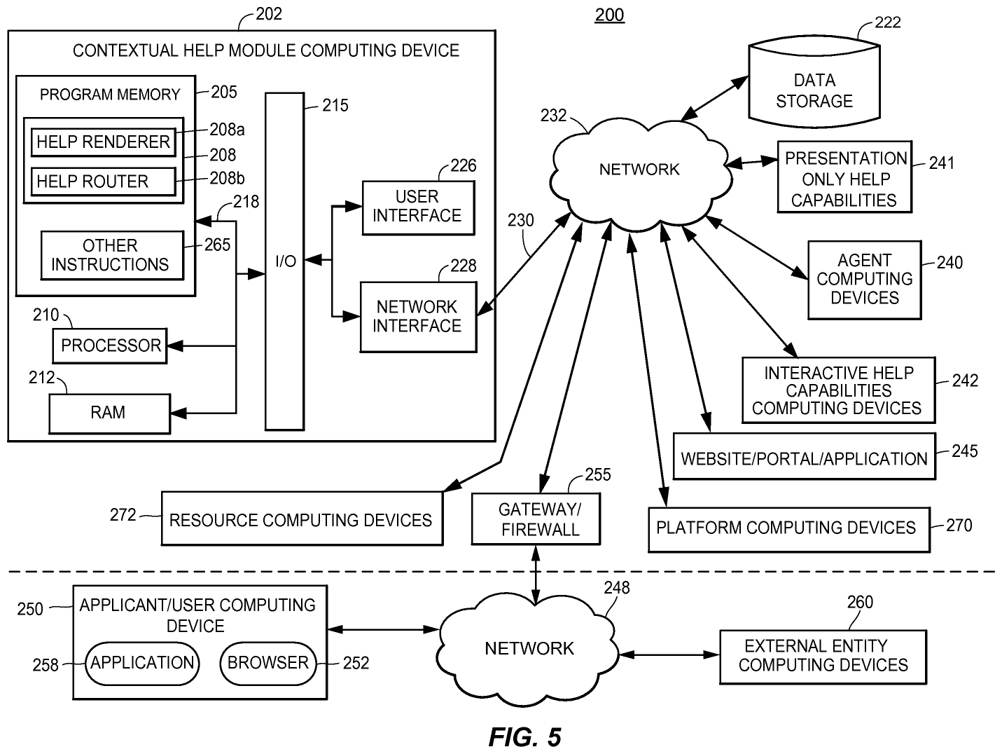

Turning now to FIG. 5, FIG. 5 includes a block diagram illustrating an exemplary system 200 utilized by an enterprise, which is also referred to interchangeably herein as an enterprise system 200. In one embodiment, the system 200 may be included in the system 10 of FIG. 1, and in another embodiment, the system 10 may be included in the system 200. In some configurations, the system 10 in the system 200 may be an integral or a same system. The system 200 may perform at least a portion of the method 100 for contextual help rendering, however, the system 200 may additionally or alternatively perform other methods of rendering contextual help. The system 200 may perform at least a portion of the method 150 for contextual help routing, however, the system 200 may additionally or alternatively perform other methods of contextual help routing.

As shown in FIG. 5, the system 200 may include a contextual help module 202 comprising one or more computing devices 202. In one embodiment, the contextual help module 202 is the contextual help module 12 of FIG. 1, and in one embodiment, the contextual help module 202 is the contextual help module 25 of FIG. 2. The contextual help module 202 comprising the one or more computing devices may include, for example, a computer, a server, a plurality of networked computing devices having a logical appearance of a single computing device, a plurality of cloud computing devices, etc. Accordingly, for ease of discussion only and not for limitation purposes, the computing device comprising the contextual help module 202 is referred to herein using the singular tense, although in some embodiments the computing device 202 may include more than one physical computing device.

The computing device 202 may include a program memory 205, a processor 210 (e.g., a controller, a microcontroller, a microprocessor, etc.), a random-access memory (RAM) 212, and an input/output (I/O) circuit 215, all of which may be interconnected via an address/data bus 218. The program memory 205 may comprise one or more tangible, non-transitory computer-readable storage media and/or devices, and may store thereon a particular set of computer-readable and/or computer-executable instructions 208a that, when executed by the processor 210, may cause the computing device 202 to provide contextual help rendering. As such, the computer-readable and/or computer-executable instructions 208a are referred to interchangeably herein as a “contextual help renderer 208a,” and in an embodiment, the instructions 208a may be Help Renderer 42a of FIG. 2. At any rate, the instructions 208a, when executed, may cause the computing device 202 to implement at least a portion of the method 100 for contextual help rendering. Additionally or alternatively, the program memory 205 may store thereon a particular set of computer-readable and/or computer-executable instructions 208b. In one embodiment, the instructions 208b may be the Help Router 42b of FIG. 2.

The instructions 208b, when executed by the processor 210, may cause the computing device 202 to provide contextual help routing. For example, the instructions 208b may cause the computing device 202 to implement at least a portion of the method 150 of contextual help routing. Accordingly, the computer-readable and/or computer-executable instructions 208b are referred to interchangeably herein as a “contextual help router 208b.”

The computing device 202 may be configured and/or adapted to access one or more data or memory storage devices 222. For example, the contextual help renderer 208a and/or the contextual help router 208b may access the one or more data storage devices 222 to read and/or write data corresponding to contextual help rendering and/or contextual help routing, respectively.

The one or more data storage devices 222 may comprise, for example, one or more memory devices, a data bank, cloud data storage, and/or one or more other suitable data storage devices. Indeed, the one or more data storage devices 222 may include one physical device, or the one or more data or memory storage devices 222 may include more than one physical device. The one or more data storage devices 222, though, may logically appear as a single data storage device irrespective of the number of physical devices included therein. Accordingly, for ease of discussion only and not for limitation purposes, the data storage device 222 is referred to herein using the singular tense. In an embodiment, the data storage device 222 is the data storage device 35 shown in FIG. 2.

The data or memory storage device 222 may be configured and/or adapted to store data related to the system 200. For example, the data storage device 222 may be configured and/or adapted to store information such as metadata 38 and capability information/data 40. Additionally or alternatively, the data storage device 222 may be configured and/or adapted to store static reference or help information such as contact information, sets of FAQs, user guides and manuals, and the like, e.g., for one or more LOBs, for the enterprise, and/or for one or more external entities 16. Further, the data storage device 222 may be configured and/or adapted to store one or more sets of routing rules 50.

In one embodiment (not shown), at least one of the one or more data storage devices 222 may be included in the computing device 202, and the processor 210 of the computing device 202 (or one or both of the sets of instructions 208a, 208b executed by the processor 210) may access the one or more data storage devices 222 via a link comprising a read or write command, function, application programming interface, plug-in, operation, instruction, and/or similar.

In the present embodiment illustrated in FIG. 2, though, the computing device 202 is shown as being configured to access the one or more data storage devices 222 via one or more network or communication interfaces 228 that are respectively coupled to a link 230 in communicative connection with the one or more data storage devices 222. The link 230 in FIG. 2 is depicted as a link to one or more private and/or public networks 232 (e.g., the one or more data storage devices 222 may be remotely located from the computing device 202), however, the network 232 is not required for the computing device 202 and the data storage device 222 to be communicatively connected. For example, the link 230 may provide a direct connection between the computing device 202 and the data storage device 222. The link 230 may include one or more wired links and/or one or more wireless links, and/or may utilize any suitable communications technology. The network 232 may include one or more proprietary networks, the public Internet, one or more virtual private networks, and/or some other type of network, such as dedicated access lines, plain ordinary telephone lines, satellite links, data networks, combinations of these, etc.

In an example, the network 232 may include a private network of the enterprise. As such, in this example, the network 232 may communicatively and/or securely connect other devices corresponding to the enterprise in addition to the computing device 202 and the data storage device 222. For example, the private network 232 may communicatively connect one or more agent computing devices 240 (e.g., stationary and/or mobile computing devices at store front and/or agent office locations and/or mobile computing devices operated by agents) to other computing devices of the system 200, and/or other computing devices external to the system 200.

In one embodiment, the network 232 may communicatively connect one or more computing devices 241 of the system 200 on which presentation-only help capabilities may be provided. For example, content of presentation-only help capabilities may be stored on or accessed by the one or more computing devices 241. For example, at least some of the content of the presentation-only capabilities may be stored in the data storage entity 222, and the one or more computing devices 241 may access the stored content on behalf of other devices in the system 200. In some configurations, the one or more computing devices 241 may allow administrative actions to be taken for the presentation-only capabilities, e.g., may allow users to create, delete, update, and/or store presentation-only capabilities and/or their respective content.

The system 200 may include and the network 232 may communicatively connect one or more computing devices 242 that may be utilized by personnel for interactive help capabilities such as email, call center, chat, and the like. For example, the computing devices 242 may include stationary and/or mobile computing devices operated by agents of one or more LOBs or of the enterprise.

Additionally or alternatively, the system 200 may include and the private network 232 may communicatively connect one or more computing devices that host one or more websites, portals, server applications, remote applications, and/or customer-facing processes of the enterprise, of a particular LOB of the enterprise, or of a particular group of LOBs of the enterprise (reference 245). For example, the website/portal computing device 245 may host a website, portal, or other remote application that is limited to access by customers of LOB 1 (reference 15a) for the purposes of providing customer interface processes for LOB 1. The website and/or remote application 245 may be accessed by customer-operated computing devices 250, for example, via a browser 252 and/or a local or client application 258 executing locally on the customer's device 250, and/or optionally via one or more external private and/or public networks 248, such as the Internet, other public data communications network, and/or other telecommunications network.

In some configurations, a secured gateway and/or firewall 255 may be disposed between any or all of the enterprise devices (e.g., the network 232, devices 202, 222, 240, 242, 245) and a public gateway and/or access point, e.g., the public network 248. In one embodiment, a computing device 260 of an external entity (e.g., that supports the external entity customer-facing process 16 of FIG. 1) may be communicatively connected to the system 200 via the network 248.

Further, in some embodiments, the system 200 may include and the network 232 may communicatively connect one or more computing devices 270 of the enterprise on which one or more of the platforms 20 are supported. Still further, in some embodiments, the system 200 may include and the network 232 may communicatively connect one or more computing devices 272 of the enterprise on which one or more of the resources 22 are provided.

It is noted that any number of any types of the computing devices included in the system 200 (e.g., 202, 232, 240, 241, 242, 245, 255, 270, 272) may be an integral, logical set of computing devices. For example, a group of computing devices 242 may be utilized by personnel for interactive help capabilities, and thus may simultaneously support one or more resources 22 that may be shared across multiple LOBs or the entire enterprise. In another configuration, the group of computing devices 242 may be utilized by personnel for interactive help capabilities, and may support multiple LOB-specific interactive help capabilities that are not shared by multiple LOBs even though they reside on the same group of computing devices.

Thus, as depicted in FIG. 5, any of the devices 222, 232, 240, 241, 242, 245, 255, 270, 272 may be communicatively connected to the contextual help module 202. Also as depicted in FIG. 5, a customer's computing device 250 may be communicatively connected to the contextual help module 202. For example, the customer's computing device 250 may be communicatively connected with the contextual help renderer 208a and/or the contextual help router 208b via a browser 252 executing on the customer's computing device 250 and the website and/or portal 245 of the providing LOB, a group of LOBs, or enterprise.

In some embodiments, a customer's computing device 250 may communicatively connect to the contextual help renderer 208a and/or the contextual help router 208b by using an application 258 (e.g., a local software and/or client application) stored and/or executing thereon. For example, a customer may download a client application 258 from a device of the enterprise or LOB, e.g., from the computing device 202, the host device of the external website and/or application 245, and/or the data storage device 222. Subsequently, the client application 258 and the contextual help renderer 208a and/or the contextual help router 208b may establish a secure connection (e.g., a secured session) for communications therebetween over one or more public networks 248 and/or over the private network 232.

Additionally or alternatively, the client application 258 and the back-end application 245 may establish a secure connection (e.g., a secured session), and the back-end application 245 may pass information between the client application 258 and the contextual help renderer 208a and/or the contextual help router 208b. As such, the system 200 and/or any of the devices and/or networks included therein (e.g., the devices 202, 222, 232, 240, 241, 242, 245, 255, 270, 272) may be back-end devices with respect to an applicant's computing device 250.

Turning now again back to FIG. 5, while the contextual help module computing device 202, the data storage device 222, and the other computing devices 232, 240, 241, 242, 245, 255, 270, 272 included in the system 200 are illustrated as separate and distinct entities, this is only one of many embodiments. Any number of any of the devices 202, 222, 240, 241, 242, 245, 255, 270, 272 may be included in the network 232, for example.

Additionally or alternatively, any number of any of the devices 202, 222, 240, 241, 242, 245, 255, 270, 272 may be a logical, combined or integral device or set of devices. For example, the contextual help module computing device 202 may host the website(s) and/or portal(s) 245 of the enterprise, and/or the firewall 255 may be incorporated into each agent computing device 240 and/or into the website, portal, and/or remote application host 245. Still, it is noted that any of the computing devices included in the system 200 (e.g., 232, 240, 241, 242, 245, 255, 270, 272) may include, for example, a computer, a server, a plurality of networked computing devices having a logical appearance of a single computing device, a plurality of cloud computing devices, etc., in a manner such as previously discussed for the computing device 202.

With particular regard to the contextual help module 202, in addition to the contextual help renderer 208a and/or the contextual help router 208b, the program memory 205 may store thereon further computer-readable or computer-executable instructions 265 that further particularly configure the computing device 202 and that may be executed in conjunction with contextual help applications. For example, the other instructions 265 may execute to allow agents of the LOBs and/or of the enterprise to update or modify routing rules 50 and/or routing criteria. The other instructions 265 may manage the downloading and/or provision of client applications 258 to client computing devices 250. The other instructions 265 may store connectivity, status, and/or identification information of capabilities 18, platforms 20, and/or resources 22. Other functions corresponding to contextual help may be performed by the instructions 265. In some embodiments, at least a portion of the instructions 265 may be integral with at least a portion of the instructions 208a and/or 208b.

Further, with regard to the computing device 202, while the contextual help renderer 208a and the contextual help router 208b each is shown as a single block in FIG. 5, it will be appreciated that the contextual help renderer 208a and the contextual help router 208b each may include any number of different programs, modules, routines, and/or sub-routines that may collectively cause the computing device 202 to implement their respective functionality. Similarly, while the other instructions 265 is shown as a single block, it will be appreciated that the other instructions 265 may include a number of different programs, modules, routines, and/or sub-routines that may collectively cause the computing device 202 to implement the other instructions 265.

Still further, it should be appreciated that although only one processor 210 is shown, the computing device 202 may include multiple processors 210. Additionally, although the I/O circuit 215 is shown as a single block, it should be appreciated that the I/O circuit 215 may include a number of different types of I/O circuits. Similarly, the memory of the computing device 202 may include multiple RAMs 212 and/or multiple program memories 205. Further, while the contextual help renderer 208a, the contextual help router 208b, and/or the other instructions 265 are shown being stored in the program memory 205, any or all of the instructions 208a, 208b, 265 may additionally or alternatively be partially or entirely stored in the RAM 212 and/or other suitable local memory (not shown).

The RAM(s) 212 and/or program memories 205 may be implemented as semiconductor memories, magnetically readable memories, chemically or biologically readable memories, and/or optically readable memories, and/or may utilize any suitable memory technology or technologies. The computing device 202 may also be operatively connected to the network 232 via the link 230 and the I/O circuit 215, in some embodiments.

Moreover, although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims. By way of example, and not limitation, the disclosure herein contemplates at least the following aspects indicated below.

### VII. Exemplary Contextual Help Module

In one aspect, a contextual help module for an enterprise having a plurality of lines-of-business (LOBs) may include an input to receive a respective identifier of any (and/or an individual or specific) line-of-business (LOB) of the plurality of lines-of-business of the enterprise. The respective identifier of the LOB may be received, for example, at a respective display view that is provided by the any LOB and with which the contextual help module is integrated. The contextual help module may further include computer-executable instructions stored on one or more memories and executable by one or more processors to determine a particular help capability included in a set of help capabilities that are particular to the any LOB, and that are configured to allow a user to obtain information pertaining to the any LOB. The determination of the particular help capability may be based upon the respective identifier of the any LOB and a set of routing rules. Additionally, the computer-executable instructions may be executable to cause the particular help capability to receive data indicative of an interaction of the user at the respective display view provided by the any LOB, and to present, at the respective display view provided by the any LOB, data generated by the particular help capability in response to receiving the data indicative of the user interaction.

In one embodiment, the plurality of lines-of-business of the enterprise may include at least one of an insurance provider or a financial services provider.

The set of help capabilities of the any LOB may include at least one of: a telephone number, a set of Frequently Asked Questions (FAQs) and corresponding answers, a set of knowledge-based articles, a chat capability, an email capability, a call-back capability, a capability to enable the user to communicate with an agent of the any LOB, a capability to enable the user to communicate with an agent who services multiple LOBs of the enterprise, and/or a help capability unique to the any LOB among the plurality of LOBs. In one embodiment, at least one help capability of the set of help capabilities of the any LOB may be unique to the any LOB among the plurality of LOBs. In another embodiment, at least one help capability of the set of capabilities of the any LOB may be shared across multiple LOBs of the enterprise.

In some configurations, at least a portion of the set of routing rules may be provided by the enterprise. Additionally or alternatively, in some configurations, at least another portion of the set of routing rules may be provided by the any LOB.

The set of routing rules may include one or more rules that are based upon one or more routing criteria from a set of routing criteria. The set of routing criteria may include at least one of: a type of help capability, an available capacity of one or more help capabilities, an availability of a respective connection to the one or more help capabilities, a respective hours of operation of the one or more help capabilities, a display type of the display view, a device type on which the display view is presented, a respective priority of the one or more help capabilities, an indication of associate or employee of the LOB and/or of the enterprise, a language, a sub-line-of-business of the any LOB, a functional area of the any LOB, a location corresponding to the user, other information indicative of the user, a user selection, and/or an elapsed time between user interactions with the respective display view provided by the any LOB. In some situations, a respective value of at least one of the one or more routing criteria may be determined by the contextual help module from the respective display view provided by the any LOB.

In one embodiment, the interaction of the user at the respective display view provided by the any LOB may be included in a customer interaction session of the user, and/or the data indicative of the user interaction at the respective display view provided by the any LOB may be included in data corresponding to the customer interaction session. In such an embodiment, the computer-executable instructions may be further executable to route at least some of the data corresponding to the customer interaction session to a receiving help capability included in the set of help capabilities of the any LOB to service at least a portion of the customer interaction session. In some cases, the receiving help capability may be the particular help capability.

The respective identifier of the any LOB may be indicative of a subscription of the any LOB to the contextual help module. Additionally or alternatively, the contextual help module may be subscribed to by an entity that is external to the enterprise, e.g., an external entity, in an embodiment. In such an embodiment, the contextual help module may be integrated into a display view provided by the external entity, the input may further be to receive a respective identifier of the external entity, and/or the contextual help module may include further computer-executable instructions that are executable to (i) determine, based upon the respective identifier of the external entity, a particular help capability included in a set of help capabilities particular to the external entity and/or configured to allow the user to obtain information of the external entity; (ii) cause the particular help capability of the external entity to receive data indicative of an interaction of the user at the display view provided by the external entity; and/or (iii) present, at the display view provided by the external entity, data generated by the particular help capability of the external entity in response to receiving the data indicative of the user interaction with the display view of the external entity.

The respective display view provided by the any LOB may be at least one of: presented on a stationary or a mobile device operated by the user, included in an application provided by the any LOB, and/or included in a website provided by the any LOB. In some embodiments, a subset of the set of help of capabilities of the any LOB may be determined based upon the set of routing rules, and/or the particular help capability may be selected by the user from the subset of the set of help capabilities.

Further, the contextual help module may include additional, fewer, or alternate components and/or provide additional, less, or alternate functionality, including that discussed elsewhere herein.

### VIII. Additional Exemplary Contextual Help Module

In one aspect, a contextual help module for an enterprise having a plurality of lines-of-business (LOBs) may include an input to receive a respective identifier of any (and/or a specific or individual) line-of-business (LOB) of the plurality of lines-of-business of the enterprise. The respective identifier of the any LOB may be received at a respective display view with which the contextual help module is integrated and that is provided by the any LOB. Additionally, the contextual help module may include computer-executable instructions stored on one or more memories and executable by one or more processors to (i) determine, based upon the respective identifier of the any LOB, a set of help capabilities particular to the any LOB and/or configured to allow a user to obtain information about the any LOB; (ii) provide, in conjunction with the respective display view provided by the any LOB, a respective indication of each member of the set of help capabilities of the any LOB; (iii) receive an indication of a user selection of one of the members of the set of help capabilities of the any LOB; (iv) provide, in conjunction with the respective display view provided by the any LOB and/or based upon the user selection, information particular to the selected help capability of the set of help capabilities of the any LOB; and/or (v) provide, to the any LOB, data indicative of the user selection of the selected help capability of the any LOB.

In some embodiments, the plurality of lines-of-business of the enterprise may include at least one of an insurance provider or a financial services provider.

In some embodiments, the input may be to receive a plurality of indications; and/or the plurality of indications may include the respective identifier of the any LOB and a respective indication of at least one of: a geographic location of the user, other information indicative of the user, an indication of an associate or employee of the any LOB, an indication of a preferred language, and/or an indication of a display type of the contextual help module. Further, at least one of: (i) the indications of the members of set of help capabilities of the any LOB, (ii) the information particular to the selected help capability provided on the respective display view, and/or (iii) the data indicative of the user selection of the selected help capability is based upon the plurality of indications received at the input of the contextual help module.

The set of help capabilities of the any LOB may include at least one of: a telephone number, a set of Frequently Asked Questions (FAQs) and corresponding answers, a set of knowledge-based articles, a chat capability, an e-mail capability, a call-back capability, a capability to enable the user to communicate with an agent of the any LOB, a capability to enable the user to communicate with an agent that services multiple LOBs of the enterprise, and/or a help capability unique to the any LOB among the plurality of LOBs.

In some configurations, the user selection may be included in a customer interaction session of the user, an indication of the user selection may be included in data corresponding to the customer interaction session, and the computer-executable instructions may be further executable to route at least some of the data corresponding to the customer interaction session to a receiving help capability included in the set of help capabilities of the any LOB to service at least a portion of the customer interaction session. The receiving help capability may be determined based upon the respective identifier of the any LOB, the user selection, and/or at least one of: a type of help capability, an available capacity of one or more help capabilities, an availability of a respective connection to the one or more help capabilities, a respective hours of operation of the one or more help capabilities, a display type of the contextual help module, a respective priority of the one or more help capabilities, an indication of associate or employee of the enterprise, a language, a sub-line-of-business of the any LOB, a functional area of the any LOB, and/or a location corresponding to the user.

In some embodiments, the contextual help module may include other computer-executable instructions that may be executable to, when the selected help capability of the any LOB is unavailable, determine an alternate help capability of the any LOB and/or present an indication of the alternate help capability on the respective display view provided by the any LOB. The alternate help capability may be shared across multiple LOBs of the enterprise, for instance.

Further, the contextual help module may include additional, fewer, or alternate components and/or provide additional, less, or alternate functionality, including that discussed elsewhere herein.

### IX. Further Exemplary Contextual Help Modules

In one aspect, a contextual help module for an enterprise having multiple lines-of-business (LOBs) may be provided. The contextual help module may include (1) an input indicative of, and/or an input means for receiving, a respective identifier of a specific line-of-business (LOB) of the multiple lines-of-business of the enterprise, the specific LOB providing a respective display view with which the contextual help module is integrated; and/or (2) computer-executable instructions stored on one or more memories and executable by one or more processors to: (i) based upon the respective identifier of the specific LOB and a set of routing rules, determine a particular help capability included in a set of help capabilities particular to the specific LOB and configured to allow a user to obtain information pertaining to the specific LOB; (ii) cause the particular help capability to receive data indicative of an interaction of the user at the respective display view provided by the specific LOB; and/or (iii) present, at the respective display view provided by the specific LOB, data generated by the particular help capability in response to receiving the data indicative of the user interaction to facilitate providing help to an online customer and/or enhancing an online customer experience. The multiple LOBs of the enterprise may include at least one of an insurance provider or a financial services provider. The respective identifier for the specific LOB may be generated and/or received by the contextual help module when the user selects an indication or icon associated with the specific LOB or a product/service offered by the specific LOB (such as by using a mouse or other input device), the indication or icon being displayed on a display of a computing device. The contextual help module may include additional, less, or alternate functionality, including that discussed elsewhere herein.

In another aspect, a contextual help module for an enterprise having multiple lines-of-business (LOBs) may be provided. The contextual help module may include: (1) an input (or trigger event or flag functionality) indicative of, and/or an input means for receiving, a respective identifier of a specific line-of-business (LOB) of the multiple lines-of-business of the enterprise, the specific LOB providing a respective display view with which the contextual help module is integrated; and/or (2) computer-executable instructions stored on one or more memories and executable by one or more processors to: (i) determine, based upon the respective identifier of the specific LOB, a set of help capabilities particular to the specific LOB and configured to allow a user to obtain information about the specific LOB; (ii) provide, in conjunction with the respective display view provided by the specific LOB, a respective indication of each member of the set of help capabilities of the specific LOB; (iii) receive an indication of a user selection of one of the members of the set of help capabilities of the specific LOB; (iv) provide, in conjunction with the respective display view provided by the specific LOB and based upon the user selection, information particular to the selected help capability of the set of help capabilities of the specific LOB; and/or (v) provide, to the specific LOB, data indicative of the user selection of the selected help capability of the specific LOB to facilitate providing help to an online customer and/or enhance an online customer experience. The respective identifier for the specific LOB may be generated and/or received by the contextual help module (and/or input means) when the user selects an indication or icon associated with the specific LOB or a product/service offered by the specific LOB, the indication or icon being displayed on a display of a computing device. The contextual help module may include additional, less, or alternate functionality, including that discussed elsewhere herein.

### X. Further Exemplary Methods

In one aspect, a computer implemented method of providing online help to a customer may be provided. The method may include: (1) receiving, via one or more processors, an input indicative of a respective identifier of a specific line-of-business (LOB) of multiple lines-of-businesses of the enterprise (and/or otherwise the respective identifier of the specific LOB); (2) based upon the respective identifier of the specific LOB and a set of routing rules, determining, via the one or more processors, a particular help capability included in a set of help capabilities particular to the specific LOB and configured to allow a user to obtain information pertaining to the specific LOB; (3) causing, via the one or more processors, the particular help capability to receive data indicative of an interaction of the user at a respective display view provided by the specific LOB; and/or (4) presenting, via the one or more processors, at the respective display view provided by the specific LOB, data generated by the particular help capability in response to receiving the data indicative of a user interaction to facilitate providing help to an online customer and/or enhancing an online customer experience. The set of routing rules may include two or more of: a customer location, customer language, functional area, LOB, or Sub-LOB, and a specific web page is presented to the customer based upon the set of routing rules. The method may include additional, less, or alternate actions, including those discussed elsewhere herein (such as in conjunction with the contextual help module discussion).

In another aspect, a computer implemented method of providing online help to a customer may be provided. The method may include: (1) receiving, via one or more processors, a respective identifier, and/or an input indicative of the respective identifier, of a specific line-of-business (LOB) of multiple lines-of-businesses of the enterprise; (2) determining, via the one or more processors, based upon the respective identifier of the specific LOB, a set of help capabilities particular to the specific LOB and configured to allow a user to obtain information about the specific LOB; (3) providing, via the one or more processors, in conjunction with a respective display view provided by the specific LOB, a respective indication of each member of the set of help capabilities of the specific LOB; (4) receiving, via the one or more processors, an indication of a user selection of one of the members of the set of help capabilities of the specific LOB; (5) providing, via the one or more processors, in conjunction with the respective display view provided by the specific LOB and based upon the user selection, information particular to the selected help capability of the set of help capabilities of the specific LOB; and/or (6) providing, via the one or more processors, to the specific LOB, data indicative of the user selection of the selected help capability of the specific LOB to facilitate providing help to an online customer and/or enhancing an online customer experience. The set of routing rules may include two or more of: a customer location, customer language, functional area, LOB, and/or Sub-LOB, and a specific web page is presented to the customer based upon the set of routing rules. The method may include additional, less, or alternate actions, including those discussed elsewhere herein.

### XI. Additional Considerations

Additionally, certain embodiments are described herein as including logic or a number of functions, components, modules, blocks, or mechanisms. Functions may constitute either software modules (e.g., non-transitory code or instructions stored on a tangible, non-transitory machine-readable storage medium) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain functions. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example functions and methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or functions described herein may be at least partially processor-implemented. For example, at least some of the functions of a method may be performed by one or processors or processor-implemented hardware modules. The performance of certain of the functions may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the functions may be performed by a group of computers (as examples of machines including processors), these operations being accessible via a network (e.g., the Internet) and via one or more appropriate interfaces (e.g., application program interfaces (APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data and data structures stored as bits or binary digital signals within a machine memory (e.g., a computer memory). These algorithms or symbolic representations are examples of techniques used by those of ordinary skill in the data processing arts to convey the substance of their work to others skilled in the art. As used herein, a “method” or a “function” or an “algorithm” or a “routine” is a self-consistent sequence of operations or similar processing leading to a desired result. In this context, methods, functions, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a function, process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments of a computer system 202 for purposes of illustration only. One of ordinary skill in the art will readily recognize from the following discussion that alternative embodiments of the structures and methods illustrated herein may be employed without departing from the principles described herein.

Upon reading this disclosure, those of skill in the art will appreciate still additional alternative structural and functional designs for a system and method of providing a flexible vehicle loan application process through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A contextual help module for an enterprise having a plurality of sub-entities, the contextual help module comprising:
an input to receive a respective identifier of any sub-entity of the plurality of sub-entities of the enterprise, the any sub-entity providing a respective display view with which the contextual help module is integrated and wherein the respective identifier of the any sub-entity is an indication of a subscription of the any sub-entity to the contextual help module; and
computer-executable instructions stored on one or more memories and executable by one or more processors to:
based upon the respective identifier of the any sub-entity and the indication of a subscription, retrieve customer data associated with the subscription;
based upon the respective identifier of the any sub-entity, the customer data, and a set of routing rules, determine a particular help capability included in a set of help capabilities particular to the any sub-entity and configured to allow a user to obtain information pertaining to the any sub-entity;
cause the particular help capability to receive data indicative of an interaction of the user at the respective display view provided by the any sub-entity; and
present, at the respective display view provided by the any sub-entity, data generated by the particular help capability in response to receiving the data indicative of the user interaction.

2. The contextual help module of claim 1, wherein the plurality of sub-entities of the enterprise include at least one of an insurance provider or a financial services provider.

3. The contextual help module of claim 1, wherein the set of help capabilities particular to the any sub-entity includes at least one of: a telephone number, a set of Frequently Asked Questions (FAQs) and corresponding answers, a set of knowledge-based articles, a chat capability, an email capability, a call-back capability, a capability to enable the user to communicate with an agent of the any sub-entity, a capability to enable the user to communicate with an agent who services multiple sub-entities of the enterprise, a help capability that is unique to the any sub-entity among the plurality of sub-entities, or a help capability that is shared across multiple sub-entities of the enterprise.

4. The contextual help module of claim 1, wherein at least one of:
a first portion of the set of routing rules is provided by the enterprise; or
a second portion of the set of routing rules is provided by the any sub-entity.

5. The contextual help module of claim 1, wherein the set of routing rules includes one or more rules based upon one or more routing criteria from a set of routing criteria including at least one of: a type of help capability, an available capacity of one or more help capabilities, an availability of a respective connection to the one or more help capabilities, a respective hours of operation of the one or more help capabilities, a display type of the display view, a device type on which the display view is presented, a respective priority of the one or more help capabilities, an indication of an associate or employee of the sub-entity and/or of the enterprise, a language, a sub-line-of-business of the any sub-entity, a functional area of the any sub-entity, a location corresponding to the user, other information indicative of the user, a user selection, or an elapsed time between user interactions with the respective display view provided by the any sub-entity.

6. The contextual help module of claim 5, wherein a value of at least one of the one or more routing criteria is determined by the contextual help module from the respective display view provided by the any sub-entity.

7. The contextual help module of claim 1, wherein the contextual help module further includes instructions to present, at the respective display view provided by the any sub-entity, the customer data.

8. The contextual help module of claim 1, wherein:
the contextual help module is subscribed to by an entity external to the enterprise, the entity external to the enterprise being an external entity;
the contextual help module is integrated into a display view provided by the external entity;
the input is further to receive a respective identifier of the external entity; and
the contextual help module comprises further computer-executable instructions that are executable to:
determine, based upon the respective identifier of the external entity, a particular help capability included in a set of help capabilities particular to the external entity and configured to allow the user to obtain information of the external entity;
cause the particular help capability of the external entity to receive data indicative of an interaction of the user at the display view provided by the external entity; and
present, at the display view provided by the external entity, data generated by the particular help capability of the external entity in response to receiving the data indicative of the user interaction with the display view of the external entity.

9. A contextual help module for an enterprise having a plurality of sub-entities, the contextual help module comprising:
an input to receive a respective identifier of any sub-entity of the plurality of sub-entities of the enterprise, the any sub-entity providing a respective display view with which the contextual help module is integrated and wherein the respective identifier of the any sub-entity is an indication of a subscription of the any sub-entity to the contextual help module; and
computer-executable instructions stored on one or more memories and executable by one or more processors to:
retrieve, based upon the respective identifier of the any sub-entity and the indication of a subscription, customer data associated with the subscription;
determine, based upon the respective identifier of the any sub-entity and the customer data, a set of help capabilities particular to the any sub-entity and configured to allow a user to obtain information about the any sub-entity;
provide, in conjunction with the respective display view provided by the any sub-entity, a respective indication of each member of the set of help capabilities of the any sub-entity;
receive an indication of a user selection of one of the members of the set of help capabilities of the any sub-entity;
provide, in conjunction with the respective display view provided by the any sub-entity and based upon the user selection, information particular to the selected help capability of the set of help capabilities of the any sub-entity; and
provide, to the any sub-entity, data indicative of the user selection of the selected help capability of the any sub-entity.

10. The contextual help module of claim 9, wherein the plurality of sub-entities of the enterprise include at least one of an insurance provider or a financial services provider.

11. The contextual help module of claim 9, wherein:
the input is to receive a plurality of indications;
the plurality of indications include the respective identifier of the any sub-entity and a respective indication of at least one of: a geographic location of the user, other information indicative of the user, an indication of an associate or employee of the any sub-entity, an indication of a preferred language, or an indication of a display type of the contextual help module; and
at least one of:
(i) the indications of the members of set of help capabilities of the any sub-entity are based upon the plurality of indications received at the input of the contextual help module,
(ii) the information particular to the selected help capability provided on the respective display view is based upon the plurality of indications received at the input of the contextual help module, or
(iii) the data indicative of the user selection of the selected help capability is based upon the plurality of indications received at the input of the contextual help module.

12. The contextual help module of claim 9, wherein the set of help capabilities of the any sub-entity includes at least one of: a telephone number, a set of Frequently Asked Questions (FAQs) and corresponding answers, a set of knowledge-based articles, a chat capability, an e-mail capability, a call-back capability, a capability to enable the user to communicate with an agent of the any sub-entity, a capability to enable the user to communicate with an agent that services multiple sub-entities of the enterprise, or a help capability unique to the any sub-entity among the plurality of sub-entities.

13. The contextual help module of claim 9, wherein:
the user selection is included in a customer interaction session of the user, an indication of the user selection is included in data corresponding to the customer interaction session;
the computer-executable instructions are further executable to route at least some of the data corresponding to the customer interaction session to a receiving help capability included in the set of help capabilities of the any sub-entity to service at least a portion of the customer interaction session; and
the receiving help capability is determined based upon the respective identifier of the any sub-entity, the user selection, and at least one of: a type of help capability, an available capacity of one or more help capabilities, an availability of a respective connection to the one or more help capabilities, a respective hours of operation of the one or more help capabilities, a display type of the contextual help module, a respective priority of the one or more help capabilities, an indication of associate or employee of the enterprise, a language, a sub-line-of-business of the any sub-entity, a functional area of the any sub-entity, or a location corresponding to the user.

14. The contextual help module of claim 9, wherein:
the selected help capability of the any sub-entity is unavailable, and
the contextual help module comprises other computer-executable instructions that are executable to determine an alternate help capability of the any sub-entity and present an indication of the alternate help capability on the respective display view provided by the any sub-entity.

15. A contextual help module for an enterprise having multiple sub-entities, the contextual help module comprising:
an input indicative of, and/or an input means for receiving, a respective identifier of a specific sub-entity of the multiple sub-entities of the enterprise, the specific sub-entity providing a respective display view with which the contextual help module is integrated and wherein the respective identifier of the any sub-entity is an indication of a subscription of the any sub-entity to the contextual help module; and
computer-executable instructions stored on one or more memories and executable by one or more processors to:
based upon the respective identifier of the any sub-entity and the indication of a subscription, retrieve customer text associated with the subscription;
based upon the respective identifier of the specific sub-entity, the customer data, and a set of routing rules, determine a particular help capability included in a set of help capabilities particular to the specific sub-entity and configured to allow a user to obtain information pertaining to the specific sub-entity;
cause the particular help capability to receive data indicative of an interaction of the user at the respective display view provided by the specific sub-entity; and
present, at the respective display view provided by the specific sub-entity, data generated by the particular help capability in response to receiving the data indicative of the user interaction to facilitate providing help to an online customer and/or enhancing an online customer experience.

16. The contextual help module of claim 15, wherein the multiple sub-entities of the enterprise include at least one of an insurance provider or a financial services provider, and/or the respective identifier for the specific sub-entity is generated and/or received by the contextual help module when the user selects an indication or icon associated with the specific sub-entity or a product/service offered by a specific LOB, the indication or icon being displayed on a display of a computing device.

17. The contextual help module of claim 15, wherein the set of help capabilities particular to the specific sub-entity includes at least one of: a telephone number, a set of Frequently Asked Questions (FAQs) and corresponding answers, a set of knowledge-based articles, a chat capability, an email capability, a call-back capability, a capability to enable the user to communicate with an agent of the specific sub-entity, a capability to enable the user to communicate with an agent who services multiple LOBs of the enterprise, a help capability unique to the specific sub-entity among the multiple sub-entities, or a help capability that is shared across multiple sub-entities of the enterprise.

18. The contextual help module of claim 15,
wherein the set of routing rules includes one or more rules based upon one or more routing criteria from a set of routing criteria including at least one of: a type of help capability, an available capacity of one or more help capabilities, an availability of a respective connection to the one or more help capabilities, a respective hours of operation of the one or more help capabilities, a display type of the display view, a device type on which the display view is presented, a respective priority of the one or more help capabilities, an indication of an associate or employee of the specific sub-entity and/or of the enterprise, a language, a sub-line-of-business of the specific sub-entity, a functional area of the specific sub-entity, a location corresponding to the user, other information indicative of the user, a user selection, or an elapsed time between user interactions with the respective display view provided by the specific sub-entity; and
wherein a value of at least one of the one or more routing criteria is determined by the contextual help module from the respective display view provided by the specific sub-entity.

19. The contextual help module of claim 15, wherein:
the interaction of the user at the respective display view provided by the specific sub-entity is included in a customer interaction session of the user;
the data indicative of the user interaction at the respective display view provided by the specific sub-entity is included in data corresponding to the customer interaction session; and
the computer-executable instructions are further executable to route at least some of the data corresponding to the customer interaction session to a receiving help capability included in the set of help capabilities of the specific sub-entity to service at least a portion of the customer interaction session.

20. The contextual help module of claim 19, wherein the receiving help capability is the particular help capability.
